(19) United States
(12) Patent Application Publication
(10) Pub. No.: US 2026/0290381 A1
(43) Pub. Date: Sep. 24, 2026

(54) SYSTEM

(71) Applicant: SoftBank Group Corp., Tokyo (JP)

(72) Inventor: Dai WATANABE, Tokyo (JP)

(73) Assignee: SoftBank Group Corp., Tokyo (JP)

(21) Appl. No.: 19/568,811

(22) Filed: Mar. 17, 2026

(30) Foreign Application Priority Data
Mar. 19, 2025 (JP) 2025-045218

(51) Int. Cl. G10L 25/63; G06F 40/284; G06F 40/30

(52) U.S. Cl. CPC G10L 25/63; G06F 40/284; G06F 40/30

(57) ABSTRACT

A system includes a processor that is configured to analyze, by using a generative AI model, text, videos, and images that are to be posted to a social networking service, and evaluate a flame risk of the text, the videos, and the images by comparing analysis results with past flame cases, input, to the generative AI model, a prompt for instructing generation of text for avoiding a flame, and recommend restriction of publication of posted videos or images, and recognize, by using the generative AI model, a user emotion and generate feedback for reducing the flame risk based on the user emotion.

### CROSS-REFERENCE TO RELATED APPLICATION

This application is based on and claims priority under 35 USC 119 from Japanese Patent Application No. 2025-045218 filed on Mar. 19, 2025, the disclosure of which is incorporated by reference herein.

### BACKGROUND

### Technical Field

The present disclosure relates to a system.

### Related Art

Japanese Patent Application Laid-Open (JP-A) No. 2022-180282 discloses a persona chatbot control method executed by at least one processor. The method includes steps of: receiving a user utterance, adding the user utterance to a prompt including a description of a chatbot character and an associated instruction sentence, encoding the prompt, and inputting the encoded prompt to a language model to generate a chatbot utterance responding to the user utterance.

In recent years, social networking services (SNS) have become a primary medium for individuals and organizations to disseminate information, express opinions, and communicate with others. However, posts made on SNS can rapidly spread to a large audience and may trigger severe public backlash or “flame” events when the content is perceived as discriminatory, offensive, privacy-infringing, or otherwise inappropriate. Conventional content moderation technologies mainly focus on detecting clearly prohibited expressions or predetermined keywords, and thus often fail to accurately evaluate a nuanced risk of future backlash that depends on context, user emotion, and similarity to past flame cases. Moreover, existing systems generally provide only binary judgments such as “allowed” or “not allowed,” and do not actively assist users in reformulating their posts into safer expressions or in deciding whether to limit publication of sensitive images or videos. As a result, users lack effective tools to understand and manage flame risk before posting, and service providers lack mechanisms to give fine-grained feedback that takes into account both content and the user's emotional state. There is therefore a need for a system that can, prior to publication, analyze SNS text, images, and videos, evaluate flame risk based on past flame cases, generate prompts to a generative AI model to obtain safer alternative text, recommend restriction of publication for high-risk multimedia content, and recognize user emotion in order to provide feedback tailored to reducing the flame risk.

### SUMMARY

To solve the foregoing problems, according to one aspect of the present invention, there is provided a system comprising a processor configured to analyze, by using a generative AI model, text, videos, and images that are to be posted to a social networking service, and to evaluate a flame risk by comparing analysis results with past flame cases. In one embodiment, the processor extracts features from the text, the videos, and the images, inputs the features into the generative AI model or associated classifiers, and computes a risk score and risk level that reflect a likelihood of public backlash. The processor is further configured to input, to the generative AI model, a prompt that instructs generation of alternative text for avoiding a flame, so that the generative AI model outputs revised text that preserves a user's intent while reducing offensive, discriminatory, or otherwise risky expressions. The processor is also configured to recommend restriction of publication of posted videos or images when the flame risk evaluated for such multimedia content exceeds a threshold or when specific risk conditions, such as privacy invasion or humiliation of identifiable individuals, are detected. Additionally, the processor is configured to recognize a user emotion by using the generative AI model, based on, for example, the wording, tone, or interaction history of the user, and to generate feedback for reducing the flame risk in accordance with the recognized user emotion, such as suggesting calmer wording for an angry user or more neutral expressions for a highly emotional post. In certain embodiments, the processor analyzes content of posts on the social networking service by using natural language processing techniques, and analyzes posted images and videos by using image recognition techniques, thereby enabling multimodal, context-aware risk evaluation and adaptive guidance to the user before publication.

The term “social networking service” refers to an online service or platform that enables users to create accounts, generate and share posts including text, images, videos, and other content, and interact with other users through mechanisms such as comments, likes, messages, or reposts.

The term “post” refers to any unit of content that a user creates or intends to publish on a social networking service, including text, images, videos, combinations thereof, and associated metadata such as timestamps or tags.

The term “generative AI model” refers to a machine learning model, such as a neural network, that is configured to generate new content including text, images, or other media in response to input data or prompts, and that can also be used to analyze, transform, or summarize existing content.

The term “flame risk” refers to a likelihood or degree of probability that a post on a social networking service will trigger negative reactions, public backlash, controversy, or widespread criticism, based on factors such as content, context, similarity to past problematic cases, and perceived offensiveness.

The term “past flame cases” refers to previously occurring posts or incidents on a social networking service, or related digital platforms, that caused public backlash, controversy, or intense negative reactions, and that are stored or represented in a database for comparison and risk evaluation.

The term “prompt” refers to a text, data structure, or control signal input to a generative AI model that instructs or guides the model to perform a specific task, such as generating safer alternative text, analyzing content, or recognizing user emotion.

The term “restriction of publication” refers to any limitation applied to the visibility, posting, or sharing of a post, image, or video on a social networking service, including canceling publication, delaying publication, limiting the audience, or recommending that the user refrain from posting.

The term “user emotion” refers to an estimated emotional state of a user, such as anger, sadness, happiness, frustration, or excitement, inferred by analysis of the user's text, interaction patterns, voice, or other signals by a generative AI model or associated classifiers.

The term “feedback for reducing the flame risk” refers to information, suggestions, warnings, or alternative expressions provided to the user to help decrease the likelihood that a post will cause public backlash, including but not limited to revised text proposals, recommendations to remove or blur images or videos, and advice about tone or wording.

The term “natural language processing” refers to a set of computational techniques for analyzing, understanding, and generating human language in text form, including but not limited to tokenization, parsing, semantic analysis, sentiment analysis, and text classification.

The term “image recognition” refers to a set of computational techniques and models for analyzing images or video frames to detect, classify, or identify objects, scenes, persons, actions, or other visual features relevant to evaluating the content of a post.

The term “processor” refers to any hardware or combination of hardware and software configured to execute instructions, perform computations, and control operations of the system, including but not limited to a central processing unit (CPU), graphics processing unit (GPU), application-specific integrated circuit (ASIC), or system-on-chip (SoC).

### BRIEF DESCRIPTION OF THE DRAWINGS

Exemplary embodiments of the present disclosure will be described in detail based on the following figures, wherein:

FIG. 1 is a schematic diagram illustrating an example of a configuration of a data processing system according to a first exemplary embodiment;

FIG. 2 is a schematic diagram illustrating an example of relevant functions of a data processing device and a smart device according to the first exemplary embodiment;

FIG. 3 is a schematic diagram illustrating an example of a configuration of a data processing system according to a second exemplary embodiment;

FIG. 4 is a schematic diagram illustrating an example of relevant functions of a data processing device and smart glasses according to the second exemplary embodiment;

FIG. 5 is a schematic diagram illustrating an example of a configuration of a data processing system according to a third exemplary embodiment;

FIG. 6 is a schematic diagram illustrating an example of relevant functions of a data processing device and a headset-type terminal according to the third exemplary embodiment;

FIG. 7 is a schematic diagram illustrating an example of a configuration of a data processing system according to a fourth exemplary embodiment;

FIG. 8 is a schematic diagram illustrating an example of relevant functions of a data processing device and a robot according to the fourth exemplary embodiment;

FIG. 9 illustrates an emotion map mapping plural emotions;

FIG. 10 illustrates an emotion map mapping plural emotions;

FIG. 11 is a sequence diagram showing the flow of data processing system processing in Example 1;

FIG. 12 is a sequence diagram showing the flow of data processing system processing in Application Example 1;

FIG. 13 is a sequence diagram showing the flow of data processing system processing in Example 2; and

FIG. 14 is a sequence diagram showing the flow of data processing system processing in Application Example 2.

### DETAILED DESCRIPTION

Description follows regarding an example of exemplary embodiments of a system according to technology disclosed herein, with reference to the appended drawings.

First, explanation follows regarding terminology employed in the following description.

In the following exemplary embodiments, a reference-numeral-appended processor (hereinafter simply referred to as “processor”) may be implemented by a single computation unit, and may be implemented by a combination of plural computation units. The processor may be implemented by a single type of computation unit, or may be implemented by a combination of plural types of computation units. Examples of computation unit include a central processing unit (CPU), a graphics processing unit (GPU), a general-purpose computing on graphics processing units (GPGPU), an accelerated processing unit (APU), and the like.

In the following exemplary embodiments, random access memory (RAM) appended with a reference numeral is memory temporarily stored with information, and is employed as working memory by a processor.

In the following exemplary embodiments, reference-numeral-appended storage is a single or plural non-volatile storage devices for storing various programs and various parameters and the like. Examples of non-volatile storage devices include flash memory (such as a solid state drive (SSD)), a magnetic disk (for example, a hard disk), magnetic tape, and the like.

In the following exemplary embodiments, a reference-numeral-appended communication interface (I/F) is an interface including a communication processor and an antenna or the like. The communication I/F has the role of communicating between plural computers. An example of a communication standard applied for the communication I/F is a wireless communication standard, such as a Fifth Generation Mobile Communication System (5G), Wi-Fi (registered trademark), Bluetooth (registered trademark), and the like.

In the following exemplary embodiments “A and/or B” has the same definition as “at least one out of A or B”. Namely, “A and/or B” may mean A alone, may mean B alone, or may mean a combination of A and B. Moreover, similar logic to “A and/or B” is applied when “and/or” is employed to link three or more items in the present specification.

### First Exemplary Embodiment

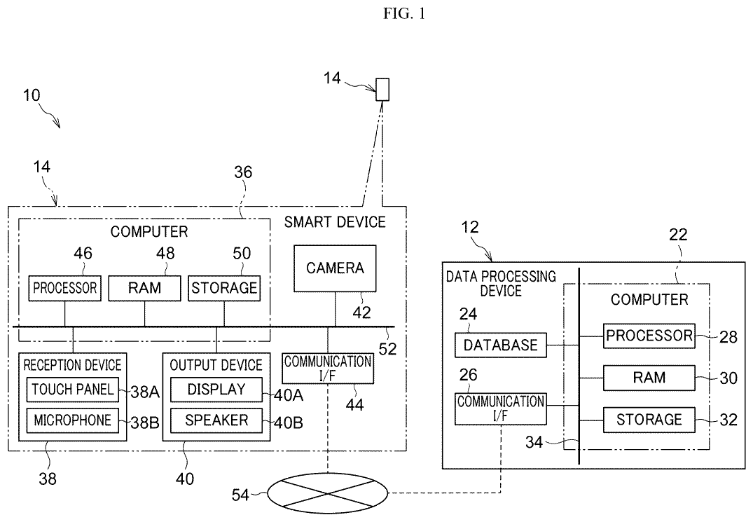

FIG. 1 illustrates an example of a configuration of a data processing system 10 according to a first exemplary embodiment.

As illustrated in FIG. 1, the data processing system 10 includes a data processing device 12 and a smart device 14. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart device 14 includes a computer 36, a reception device 38, an output device 40, a camera 42, and a communication I/F 44. The computer 36 includes a processor 46, RAM 48, and storage 50. The processor 46, the RAM 48, and the storage 50 are connected to a bus 52. The reception device 38, the output device 40, the camera 42, and the communication I/F 44 are also connected to the bus 52.

The reception device 38 includes a touch panel 38A, a microphone 38B, and the like for receiving user input. The touch panel 38A receives user input from contact of a pointer (for example, a pen, a finger, or the like) by detecting contact of the pointer. The microphone 38B receives spoken user input by detecting speech of the user. A control unit 46A in the processor 46 transmits data representing the user input received by the touch panel 38A and the microphone 38B to the data processing device 12. A specific processing unit 290 in the data processing device 12 acquires the data indicating the user input.

The output device 40 includes a display 40A, a speaker 40B, and the like for presenting data to a user 20 by outputting the data in an expression format perceivable by the user 20 (for example, audio and/or text). The display 40A displays visual information such as text, images, or the like under instruction from the processor 46. The speaker 40B outputs audio under instruction from the processor 46. The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like.

The communication I/F 44 is connected to the network 54. The communication I/F 44 and the communication I/F 26 perform the role of exchanging various information between the processor 46 and the processor 28 over the network 54.

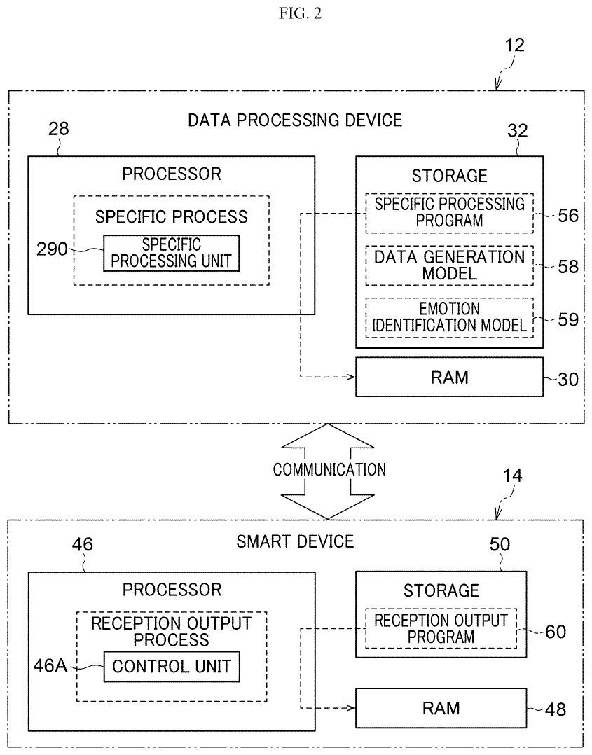

FIG. 2 illustrates an example of relevant functions of the data processing device 12 and the smart device 14.

As illustrated in FIG. 2, specific processing is performed by the processor 28 in the data processing device 12. A specific processing program 56 is stored in the storage 32. The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

A data generation model 58 and an emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart device 14. A reception and output program 60 is stored in the storage 50. The reception and output program 60 is employed by the data processing system 10 in combination with the specific processing program 56. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48. Note that a configuration may be adopted in which a similar data generation model and emotion identification model to the data generation model 58 and the emotion identification model 59 are included in the smart device 14, and these models are used to perform similar processing to the specific processing unit 290. The reception and output program is implemented by the processor 46 operating as the control unit 46A according to the reception and output program 60 executed in the RAM 48.

Note that devices other than the data processing device 12 may include the data generation model 58. For example, a server device (for example, a generation server) may include the data generation model 58. In such cases, the data processing device 12 performs communication with the server device including the data generation model 58 to obtain a processing result (prediction result or the like) obtained using the data generation model 58. The data processing device 12 may be a server device, and may be a terminal device owned by the user (for example, a mobile phone, a robot, a home electrical appliance, or the like). Next, description follows regarding an example of processing by the data processing system 10 according to the first exemplary embodiment.

### Example 1

Description follows regarding a flow of the specific processing in an Example 1. The units of the system described below are implemented by the data processing device 12 and the smart device 14. The data processing device 12 is called a “server” and the smart device 14 is called a “terminal”.

Online information sharing services increasingly accept large volumes of user-generated text and video content in real time. Conventional content review systems typically rely on fixed keyword lists, simple rule-based filters, or independent AI modules that analyze text or images in isolation. Such systems suffer from several technical limitations. First, they often fail to capture semantic relationships between multimodal content elements (for example, the combination of spoken statements, on-screen entities, and historical incident patterns) because text analysis, image analysis, and past-case retrieval are not integrated into a unified machine-processable representation. Second, conventional systems frequently perform only shallow risk scoring, without systematically aligning current content with embeddings of documented problem cases, which results in either excessive false positives or missed high-risk posts. Third, even when a risk is detected, known systems typically provide only blocking or generic warnings, and do not automatically generate machine-crafted, risk-reduced alternative text that is context-aware and guided by the concrete patterns of past incidents. As a result, servers and client devices must perform multiple fragmented processing passes, incur redundant computation and network overhead, and still provide users with low-quality guidance, thereby reducing the overall efficiency and reliability of computer-implemented content governance.

Furthermore, conventional use of generative artificial intelligence models in content moderation is usually ad hoc: prompt sentences are constructed manually or with limited context, without dynamically encoding structured risk indicators, similarity metrics to past problem cases, or detailed occurrence outcomes. This leads to unstable generative behavior, inconsistent mitigation quality, and additional trial-and-error processing on the server side. There is a need for a technical mechanism by which a server can (i) systematically convert heterogeneous input content into unified numerical representations, (ii) perform similarity-based retrieval against a repository of past problem cases, (iii) compute risk indices and risk categories with reduced computational redundancy, and (iv) automatically construct machine-readable prompt sentences that condition a generative AI model to produce targeted, risk-reduction alternatives. Without such an integrated architecture, the underlying computer system remains inefficient in memory usage, processing latency, and moderation throughput, and cannot consistently help users adjust content before publication in a technically robust manner.

Accordingly, there is a demand for a server-side technology that improves the operation of content moderation computers themselves, by tightly coupling multimodal feature extraction, vectorized comparison with historical problem cases, risk classification, and controlled use of a generative AI model via structured prompt sentences. Such a technology should reduce the number of passes over data, reduce the need for manual intervention, and allow the server to provide specific, automatically generated alternative text and publication control decisions in a single, coherent processing pipeline.

The specific processing by the specific processing unit 290 of the data processing device 12 in Example 1 is realized by the following means.

The present invention provides a server comprising a processor configured to preprocess character information and video information to be posted to an information sharing service using information analysis techniques including a natural language processing technique, an image processing technique, and optionally a speech recognition technique, extract feature information from the character information and the video information, generate numerical representations based on the extracted feature information, compare the numerical representations with numerical representations stored in association with past problem cases to calculate a risk index, execute a risk determination process that classifies a type of risk and a degree of risk related to posting content based on the risk index and the extracted feature information, and determine permission of publication or a restriction of a publication range of the posting content according to a result of the risk determination process, wherein, when it is determined that modification of the posting content is recommended, the processor is further configured to generate a structured prompt sentence including the posting content, the classified type of risk, and summary information relating to corresponding past problem cases, input the prompt sentence to a generative artificial intelligence model to cause the generative artificial intelligence model to generate alternative character information that reduces the risk related to the posting content, and notify a terminal device of the generated alternative character information together with the result of the risk determination process and update or stop publication of the posting content in response to an adoption input from a user. This enables the computer system to perform an integrated, multimodal risk assessment and mitigation workflow with reduced processing redundancy, improved use of vectorized historical incident data, and context-controlled interaction with a generative AI model, thereby enhancing the efficiency, consistency, and reliability of server-implemented content moderation.

The term “information sharing service” refers to an online service or platform that enables users to create, upload, or post content, including character information and video information, for viewing or interaction by other users over a communication network.

The term “character information” refers to information represented primarily in textual or symbolic form, including but not limited to sentences, comments, captions, titles, transcriptions, and other machine-readable text data.

The term “video information” refers to information represented primarily in time-varying visual form, optionally including associated audio information, such as moving images, recorded video files, live video streams, or sequences of still images.

The term “audio information” refers to information represented in acoustic form, including but not limited to spoken words, environmental sounds, and music, that may be contained in or associated with video information.

The term “processor” refers to a hardware logic component or a combination of hardware logic components, such as one or more central processing units, graphics processing units, or dedicated accelerators, configured to execute instructions to perform the described processing.

The term “terminal device” refers to any computing device operated by a user, such as a mobile device, a tablet device, a desktop device, or a browser-based client, that can transmit posting content to the server and receive notifications or results from the server.

The term “feature information” refers to structured data elements derived from character information, video information, or audio information by analysis, such as tokens, labels, entities, sentiment values, detected objects, scenes, or other attribute values that are usable for subsequent computation.

The term “numerical representation” refers to a machine-readable vector or other numerical structure that encodes semantic or statistical characteristics of content, including an embedding vector generated from feature information by a machine learning model. T

he term “past problem case” refers to a previously recorded instance of posting content that is associated with an undesired outcome, such as a complaint, a policy violation, or a legal issue, and for which corresponding feature information and numerical representations are stored.

The term “risk index” refers to a value or set of values, including at least one computed score, derived from a comparison between numerical representations of current posting content and numerical representations of past problem cases, and used as an indicator of a likelihood or severity of risk.

The term “risk determination process” refers to processing performed by the processor to classify one or more types of risk and degrees of risk related to posting content, based on at least the risk index and the extracted feature information.

The term “type of risk” refers to a category of potential adverse effect associated with posting content, such as defamation-related risk, privacy-related risk, intellectual property-related risk, or other content-related risk categories.

The term “degree of risk” refers to a level or magnitude assigned to a type of risk, such as a discrete level (for example, low, medium, or high) or a continuous value representing intensity or likelihood.

The term “publication range” refers to a scope or condition of making posting content accessible within the information sharing service, including full publication, restricted publication, delayed publication, or non-publication.

The term “information analysis technique” refers to a software-implemented or hardware-implemented processing method for analyzing input data, including at least a natural language processing technique, an image processing technique, and optionally a speech recognition technique.

The term “natural language processing technique” refers to a computational method for analyzing or transforming character information in a human language, including operations such as tokenization, part-of-speech tagging, sentiment analysis, entity extraction, topic extraction, or text classification.

The term “image processing technique” refers to a computational method for analyzing image data or frames of video information, including operations such as object detection, scene recognition, logo detection, text detection, or visual content classification.

The term “speech recognition technique” refers to a computational method for converting audio information, including spoken utterances, into character information, such as automatic speech-to-text conversion with or without timestamps.

The term “posting content” refers to content provided by a user for potential publication on the information sharing service, including at least character information, video information, and associated audio information.

The term “generative artificial intelligence model” refers to a machine learning model configured to generate new content, including character information, in response to an input, such as a neural network-based language model that outputs text based on a prompt sentence.

The term “prompt sentence” refers to a machine-readable instruction or input sequence provided to a generative artificial intelligence model, including structured information such as posting content, types of risk, summary information relating to past problem cases, and generation constraints.

The term “alternative character information” refers to character information generated by the generative artificial intelligence model as a modification or replacement of original character information, with the aim of reducing or mitigating a detected risk while preserving intended meaning to a predetermined extent.

The term “summary information” refers to concise descriptive data derived from a past problem case, including at least a content classification and an occurrence result, used to condition the behavior of the generative artificial intelligence model through the prompt sentence.

The term “occurrence result” refers to an outcome associated with a past problem case, such as a complaint, a takedown action, a warning, a sanction, or a dispute resolution, that characterizes the impact or consequence of the problem case.

The term “generation policy” refers to a set of constraints, preferences, or control parameters that influence how the generative artificial intelligence model generates alternative character information, including the degree of risk reduction, style, tone, or explicit avoidance of certain expressions.

The term “adoption input” refers to an input operation performed by a user through the terminal device to indicate whether generated alternative character information is accepted, partially accepted, or rejected with respect to the posting content.

The term “publication-stopped content” refers to posting content that is stored by the server but is not made accessible to other users of the information sharing service, at least until a further condition or action is satisfied.

In the following embodiments, a system according to the present invention is described with reference to exemplary hardware, software, and data processing configurations. The embodiments are illustrative and are not limiting. The subject matter of the claims can be implemented by modifying or combining the embodiments as appropriate.

### A. System Configuration

A server implements the main functions of risk assessment and content modification recommendation. The server comprises at least one processor, a main memory, a non-volatile storage device, a network interface, and optionally one or more hardware accelerators such as graphics processing units. The server is connected via one or more communication networks to a plurality of terminal devices operated by users.

A terminal is, for example, a mobile communication device, a tablet-type device, or a general-purpose computing device. The terminal includes a central processing unit, a memory, a display, an input interface such as a touch panel or pointing device, an audio input interface such as a microphone, and a network interface. The terminal executes an application or a browser program to access an information sharing service provided by the server.

A user operates the terminal to prepare posting content and to confirm or modify recommendations provided by the server. The user does not need to perform any manual analysis of risk; instead, the user interacts with an interface that reflects the internal processing of the server.

### B. Program Generation and Deployment

The server stores a program that realizes the claimed functions. In one embodiment, the server uses a general-purpose programming language, such as a high-level language for server-side development, to implement the risk analysis logic, vectorization logic, generative AI control logic, and communication logic.

The server deploys the program on an operating system such as a server-grade operating system and executes the program using one or more processor cores. The program is structured into software modules including:
(1) A data ingestion module for receiving character information, video information, and associated metadata from terminals.
(2) A feature extraction module for performing natural language processing on character information and speech recognition and image processing on video information.
(3) An embedding generation module for transforming feature information into numerical representations.
(4) A past case management module for storing, indexing, and retrieving past problem cases and their numerical representations.
(5) A risk computation module for calculating a risk index and for classifying risk types and degrees.
(6) A generative control module for constructing a prompt sentence and for communicating with a generative AI model.
(7) A result notification module for transmitting generated alternative character information and risk determination information to terminals.

### C. Hardware and Software for Feature Extraction

The server uses a natural language processing library to analyze character information. In one embodiment, the server loads a pre-trained language model implemented in a neural network framework such as a tensor-based framework, and uses it for tokenization, part-of-speech tagging, named entity recognition, sentiment analysis, and topic classification.

The server uses an image processing library and a deep learning framework for image analysis. For example, the server loads a convolutional neural network with multiple convolution layers, pooling layers, and fully connected layers to detect objects, scenes, and logos from video frames. The network parameters are stored in non-volatile storage and loaded into memory at runtime.

The server uses a speech recognition module to convert audio information into character information. In one embodiment, the server uses an acoustic model and a language model to perform end-to-end recognition. The acoustic model may be implemented as a recurrent neural network or a transformer-based network, and the language model may be implemented as a statistical or neural language model.

The server applies the natural language processing technique to both the original character information and the transcribed character information obtained from audio. The server thereby extracts feature information such as tokens, lemmas, entity identifiers, sentiment scores, topic probabilities, and toxicity flags.

The server applies the image processing technique to sampled frames from the video information. The server extracts labels for objects, scenes, logos, and sensitive visual categories, together with confidence scores for each label. The server structures this information as feature vectors and label sets.

By implementing these functions with dedicated software and hardware, the server reduces the need for the terminal to perform heavy analysis. This division of labor lowers power consumption at the terminal side and concentrates computationally intensive tasks at the server side, where specialized accelerators and optimized libraries are available.

### D. Numerical Representations and Vector Database

The server uses an embedding generation module to convert feature information into numerical representations. In one embodiment, the server loads a transformer-based sentence embedding model comprising multiple self-attention layers, feed-forward layers, and layer normalization layers. The server inputs tokenized character information to this model and obtains a dense vector of fixed dimension (for example, 768 dimensions) for each unit of content.

The server also uses a multimodal embedding model to integrate textual and visual features. For example, the server employs an architecture that comprises a text encoder and an image encoder trained on paired text-image data. The text encoder may be implemented as a transformer network, and the image encoder may be implemented as a convolutional or vision transformer network. The training process minimizes a contrastive loss that brings embeddings of related text and image pairs closer in vector space and pushes unrelated pairs apart.

The server aggregates multiple embeddings into a unified numerical representation. For example, the server averages or applies a weighted sum to embeddings of different segments of character information and to embeddings of representative video frames. The server thereby generates a single vector per posting content that represents both semantic and visual characteristics.

The server stores numerical representations for both new posting content and past problem cases in a vector database. The vector database provides approximate nearest neighbor search based on inner product or cosine similarity. The server indexes each embedding with an identifier that links to metadata, such as the type of problem case, occurrence result, and content classification.

Because the server converts heterogeneous data into fixed-dimensional numerical representations and stores them in a structure optimized for vector search, the server can retrieve similar cases with sub-linear time complexity relative to the number of stored cases. This improves processing speed and scalability compared to naive pairwise comparison.

### E. Past Problem Cases and Risk Index Computation

The server maintains a repository of past problem cases. For each past problem case, the server stores:
(1) The original character information and video information or their summaries.
(2) Extracted feature information including entities, sentiment, visual labels, and detected sensitive categories.
(3) Numerical representations produced by the embedding generation module.
(4) A content classification indicating the type of risk, such as defamation-related risk, privacy-related risk, or intellectual property-related risk.
(5) An occurrence result indicating the outcome associated with the case, such as user complaints, takedown actions, legal proceedings, or internal moderation actions. When new posting content is received, the server computes a risk index as follows. The server queries the vector database using the unified numerical representation of the posting content as an input vector. The vector database returns a list of nearest neighbor vectors corresponding to past problem cases, together with similarity scores.

The server then computes a composite risk index based on at least the following factors:
(1) A maximum similarity score among the retrieved cases.
(2) An average similarity score for a predetermined number of nearest cases.
(3) A weighted distribution of risk types among the retrieved cases, where higher weight is given to more severe occurrence results.
(4) Detected sensitive features in the current posting content, such as presence of a recognizable entity combined with strongly negative sentiment.

This numerical computation is implemented as arithmetic operations performed by the processor on floating-point vectors and scalar values. The server may implement a matrix computation library to perform these operations efficiently on hardware accelerators.

By basing the risk index on structured comparison with historical embeddings, the server improves the precision and recall of risk prediction compared to systems that use only simple rule-based filters. The server thereby reduces false positives and false negatives in automated moderation.

### F. Risk Determination and Publication Control

The server applies a risk determination process to classify a type of risk and a degree of risk based on the computed risk index and feature information. In one embodiment, the server uses a machine learning classifier implemented as a feed-forward neural network. The classifier receives as input a feature vector comprising:
(1) One or more risk index values.
(2) Sentiment scores and toxicity scores.
(3) Counts or binary flags for sensitive visual labels.
(4) Indicators for the presence of certain entities or categories.

The classifier outputs probability values for each risk type and each risk level. The server determines a type of risk and a degree of risk by selecting categories with highest probabilities or by applying a thresholding rule.

The server then determines a publication decision. For example, the server may:
(1) Permit full publication when the degree of risk is below a low threshold.
(2) Restrict publication by limiting visibility to a subset of users or by delaying publication for manual review when the degree of risk is intermediate.
(3) Recommend modification or block publication when the degree of risk exceeds a high threshold.

By performing these classifications and decisions using numerical computations implemented in software modules, the server reduces the need for human moderation and ensures consistent application of criteria. Because the model uses vectorized historical cases and multi-modal features, the decision quality and computational efficiency are improved over manual review or simple keyword filters.

### G. Construction of Prompt Sentences and Control of Generative AI Model

When the server determines that modification of the posting content is recommended, the server constructs a prompt sentence to be provided to a generative AI model. The generative AI model is, for example, a transformer-based language model with multiple self-attention layers, trained using next-token prediction on large text corpora. The model parameters are stored in a model server or a local inference engine connected to the server.

The server constructs the prompt sentence by combining several elements in a structured textual format:
(1) The original character information or a summary of the posting content.
(2) A description of detected risk types and degrees, such as “high defamation risk” or “medium privacy risk”.
(3) Summary information extracted from one or more similar past problem cases, including content classification and occurrence result.
(4) Instructions specifying the generation policy, such as “rewrite as a personal opinion without alleging criminal behavior” or “remove personal identifiers while keeping informative content”.

The server may generate, for example, the following prompt sentence:
“You are a content risk analysis assistant for an online information sharing service.
Original text: ‘This brand is terrible. Their customer support is a scam.’
Detected elements: identified organization name, very negative sentiment, strong accusation of fraudulent behavior.
Related past cases: multiple defamation-related incidents that led to complaints and takedowns.
Task:
   1. Briefly explain why this text may pose a defamation-related risk.
   2. Rewrite the text to express dissatisfaction as a personal experience without making absolute accusations of fraud.
   3. Output your answer in two parts: (A) explanation, (B) rewritten text only.”

The server may also generate a simpler prompt sentence focusing only on rewriting:
“You are helping a user rewrite a post to reduce legal and policy risks.
Original text: ‘This brand is terrible. Their customer support is a scam.’
Policy: Users may share personal opinions but should avoid asserting criminal or fraudulent behavior without evidence.
Task:
   1. Rewrite the text to keep the user's dissatisfaction clear, while removing or softening language that directly accuses fraud.
   2. Make sure the text is phrased as a personal experience.
   3. Output only the rewritten text.”

The server inputs the constructed prompt sentence to the generative AI model through an application programming interface. The server then receives generated alternative character information from the model. The server can filter or post-process the generated text, for example by re-applying the risk determination model to check that the risk degree is reduced. By explicitly encoding risk types, similarity results, and occurrence outcomes in the prompt sentence, the server conditions the generative AI model in a non-conventional way that aligns generation with risk mitigation objectives. This differs from manual or generic use of language models and contributes to more stable and targeted output.

### H. User Interaction and Technical Effects

The server transmits to the terminal information including:
(1) The classified type of risk and degree of risk.
(2) A natural language explanation summarizing reasons for the risk determination.
(3) One or more pieces of alternative character information generated by the generative AI model.

The terminal displays this information and provides user interface elements that allow the user to adopt an alternative, partially adopt it, or reject it. The user performs an adoption input corresponding to the desired option.

The server receives the adoption input and updates the posting content accordingly. If alternative character information is adopted, the server replaces the original character information with the alternative and updates stored embeddings to reflect the new content. If publication is stopped, the server marks the content as publication-stopped content and excludes it from public feeds.

Because the server performs unified multi-modal analysis, vectorized comparison against past problem cases, and structured generative prompting in an integrated pipeline, the overall system achieves several technical effects:
(1) Improved processing speed: Vector search over numerical representations and automated feature extraction reduce the need for repeated scanning of large historical datasets, thereby lowering latency.
(2) Improved accuracy: The use of embeddings and multi-modal features allows the server to detect subtle semantic and visual similarities that rule-based filters or manual checks may miss, leading to more accurate risk assessment.
(3) Reduced communication load: The server aggregates analysis results and sends only compact risk scores and alternative texts to terminals, reducing network traffic compared to transferring large raw feature sets.
(4) Enhanced data management: The vector database and structured feature storage organize historical data in a form that supports efficient retrieval and reuse, improving the scalability of moderation operations.
(5) Non-conventional control of generative models: The use of detailed prompt sentences incorporating historical incident patterns and risk classifications guides the generative AI model to output content tailored for risk reduction, rather than generic paraphrasing. These effects indicate that the system improves the functioning of the computer network and servers themselves, beyond mere automation of human judgment.

### I. Training of Models and Internal Processing

The server may also perform or coordinate training of the models used. For example, the server trains the sentence embedding model using a supervised or self-supervised learning method. The server sets a loss function such as a contrastive loss or cross-entropy loss, and updates model weights by gradient-based optimization such as stochastic gradient descent or adaptive methods.

The server trains the risk classifier using labeled data derived from past problem cases. Each data sample includes feature information and a target label for risk type and degree. The server composes a loss function such as a multi-class cross-entropy loss, computes gradients of the loss with respect to model weights, and updates the weights to minimize the loss across the training dataset.

During inference, the server applies the trained models deterministically using fixed weights. The internal processing of the models consists of linear transformations, activation functions, normalization layers, and attention mechanisms that are implemented by the processor as a sequence of numeric operations. In some embodiments, the server uses reduced precision arithmetic and batched operations to further improve throughput.

By integrating the training and inference of these models with the described data structures and algorithms, the server achieves a technical architecture in which the internal operation of the machine is specifically configured to handle risk-oriented multimodal analysis and generative control. This configuration is distinct from general-purpose computing in that it employs particular embeddings, risk indices, and prompt structures tailored for content moderation tasks.

### J. Variations and Alternative Embodiments

The server may employ alternative neural network architectures. For example, the embedding model may be a recurrent neural network, a convolutional network, or a hybrid architecture instead of a pure transformer. The image encoder may use different backbone networks, and the speech recognizer may use a connectionist temporal classification approach or an attention-based sequence-to-sequence model.

The server may vary the structure of the prompt sentence. Some embodiments may include multiple examples of safe rewrites within the prompt, or may include explicit instructions regarding length, style, or prohibited terms. Other embodiments may adapt the prompt contents based on jurisdiction, language, or type of service.

The server may vary the policy for publication control. For example, certain risk types may always trigger a manual review stage, while others may allow automatic publication when alternative character information is accepted by the user. The system can record adoption behavior by users and use it as feedback to improve thresholds and classification models.

The terminal may implement local preview or editing functions but does not need to implement heavy analysis. The division of processing between server and terminal can be adjusted depending on available hardware resources.

Through these embodiments, the server, terminal, and user cooperate in a technically specific way. The server converts heterogeneous content into structured feature information and numerical representations, performs comparison against historical embeddings with controlled complexity, calculates risk indices, and controls a generative AI model via structured prompt sentences. This configuration improves the operation of the underlying computer system and provides a concrete technological solution to the problem of reliable, efficient, and accurate content risk mitigation in information sharing services.

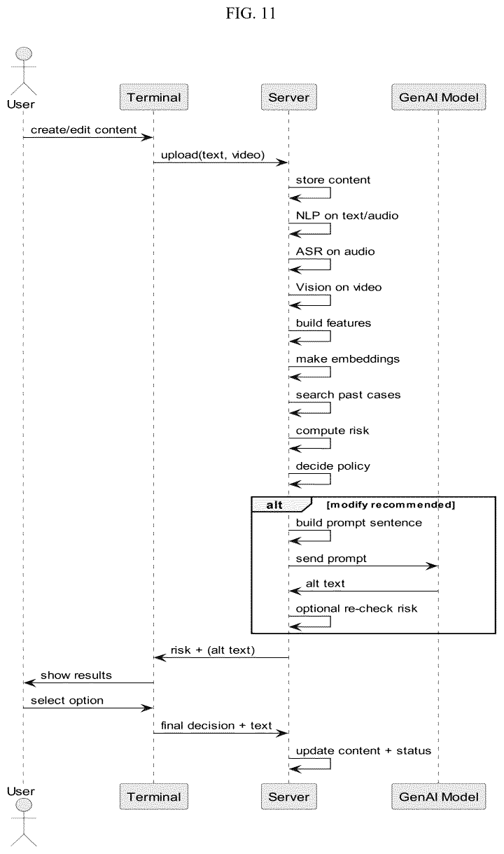

The following describes the processing flow using FIG. 11.

### Step 1:

The user operates the terminal to create posting content. The user inputs character information such as a caption or comment via a text input interface on the terminal, and optionally records or selects video information that may include audio information. The input of this step is raw user-generated content in human-readable form. The output of this step is a set of content data (character information, video file, and associated metadata such as language and intended audience) stored temporarily in the terminal's memory.

### Step 2:

The terminal transmits the posting content to the server. The terminal packages the character information, the video information, and metadata into a structured message, for example a request body encoded in a markup or structured text format, and sends the message to the server via a network using a secure transport protocol. The input of this step is the content data stored in the terminal from Step 1. The output of this step is a network request arriving at the server containing the character information, the video information, and the metadata.

### Step 3:

The server receives and stores the posting content. The server parses the received request, separates the character information, the video information, and the metadata, and writes them into storage resources such as a relational datastore for metadata and a file storage subsystem for binary video data. The input of this step is the request received from the terminal in Step 2. The server performs data parsing and persistence operations, and the output of this step is a set of stored records that uniquely identify the posting content and associate it with the user and context information.

### Step 4:

The server performs natural language preprocessing on the character information. The server loads the character information from storage, normalizes encoding, removes control characters, and segments the text into tokens and sentences using a natural language processing library. The input of this step is the raw character information string stored in Step 3. The server applies tokenization, normalization, and syntactic analysis, and the output of this step is structured text data comprising token sequences, sentence boundaries, and intermediate linguistic annotations.

### Step 5:

The server performs speech recognition on audio contained in the video information. The server extracts an audio track from the stored video file using a media processing library, then sends the audio signal to a speech recognition engine. The input of this step is the raw video file stored in Step 3. The server executes audio decoding, feature extraction (for example, generation of spectral features), and sequence decoding using an acoustic model and a language model, and the output of this step is transcribed character information representing spoken content in the video, optionally with timestamps.

### Step 6:

The server performs natural language analysis on both original and transcribed character information. The server aggregates the original text and the transcribed text, and submits them to a natural language analysis component that computes sentiment scores, identifies named entities, extracts keywords, and assigns topical categories. The input of this step is the structured text from Step 4 and the transcribed text from Step 5. The server carries out numerical scoring (for example, sentiment values), entity recognition via statistical or neural models, and keyword scoring, and the output of this step is feature information including sentiment values, lists of entities, keyword sets, and topic probabilities.

### Step 7:

The server performs visual analysis on the video information. The server decodes the stored video and samples frames at predetermined time intervals, then applies an image analysis model to each sampled frame to detect objects, scenes, logos, and sensitive visual categories. The input of this step is the video file from Step 3. The server executes frame extraction, pixel-level preprocessing, and inference using a pre-trained visual recognition network, and the output of this step is visual feature information including detected labels, confidence scores, and indicators for sensitive content across frames.

### Step 8:

The server integrates text and visual feature information into a unified feature representation. The server combines sentiment scores, entity identifiers, keyword features, and topic values from Step 6 with visual labels and confidence values from Step 7, and constructs a composite feature vector. The input of this step is the text feature information and visual feature information generated in Steps 6 and 7. The server performs feature concatenation, scaling, and normalization, and the output of this step is an integrated feature structure that numerically represents semantic and visual aspects of the posting content.

### Step 9:

The server generates numerical representations (embeddings) from the integrated feature information. The server feeds tokenized text and selected visual data to one or more embedding models, such as a sentence embedding model for text and a multimodal model for combined text and image data. The input of this step is the integrated feature structure from Step 8. The server performs matrix multiplications, non-linear transformations, and attention computations according to the neural network architecture, and the output of this step is at least one fixed-dimension numerical vector representing the posting content in an embedding space.

### Step 10:

The server retrieves similar past problem cases using the numerical representation. The server submits the embedding vector from Step 9 as a query to a vector database that stores embeddings of past problem cases. The input of this step is the query embedding corresponding to the current posting content. The server executes approximate nearest neighbor search using similarity functions such as cosine similarity, and the output of this step is a list of past problem case identifiers and corresponding similarity scores.

### Step 11:

The server computes a risk index based on similarity and feature patterns. The server takes the similarity scores and associated metadata about the retrieved past problem cases, such as risk types and occurrence results, and combines them with selected features from the current content. The input of this step is the retrieval result from Step 10 and the feature structure from Step 8. The server performs numerical aggregation, such as calculating maximum similarity, mean similarity, weighted sums over risk categories, and composite scores, and the output of this step is a set of one or more risk index values quantifying the likelihood and severity of risk.

### Step 12:

The server executes a risk determination process to classify types and degrees of risk. The server supplies the risk index values together with selected feature components to a risk classification model, for example a neural network classifier or another statistical classifier. The input of this step is the risk index set from Step 11 and reduced feature vectors derived from Step 8. The server performs forward inference through the classifier, computes category probabilities, applies decision thresholds, and the output of this step is a classification result that includes at least one type of risk and at least one degree of risk assigned to the posting content.

### Step 13:

The server determines a publication control policy based on the risk classification result. The server compares the degree of risk to configurable thresholds and applies rules that specify whether to permit publication, restrict publication, delay publication, or recommend modification. The input of this step is the risk classification result from Step 12. The server executes rule evaluation and decision logic, and the output of this step is a publication control decision value indicating the allowed publication range and whether modification of the posting content is recommended.

### Step 14:

The server decides whether to construct a prompt sentence for a generative AI model. If the publication control decision indicates that modification is recommended, the server prepares to construct a prompt sentence; otherwise, the server may skip generative processing. The input of this step is the publication control decision from Step 13. The server performs a conditional branch based on the decision state, and the output of this step is a control signal specifying that a prompt sentence should be created for the generative AI model.

### Step 15:

The server constructs a prompt sentence that encodes content and risk context. The server collects the original character information, selected excerpts from the transcribed text, the classified type and degree of risk, and summary information of relevant past problem cases, such as content classification and occurrence result. The input of this step is the original and transcribed text from Steps 4 and 5, the risk classification from Step 12, and metadata from past problem cases associated with the nearest neighbors in Step 10. The server then concatenates these elements into a structured natural language instruction according to a predefined template, and the output of this step is a prompt sentence configured to guide the generative AI model toward risk-reducing content generation.

### Step 16:

The server transmits the prompt sentence to the generative AI model and obtains alternative character information. The server sends the prompt sentence as textual input to a generative AI model via an application programming interface, then receives generated text output. The input of this step is the prompt sentence produced in Step 15. The server executes a remote or local inference call, during which the generative model performs token-level probability computation and sampling based on its parameters, and the output of this step is alternative character information that is intended to reduce or mitigate the identified risk while preserving the user's communicative intent.

### Step 17:

The server optionally re-evaluates the generated alternative character information. The server applies at least part of the analysis pipeline used for the original content, including feature extraction, embedding generation, and risk determination, to the generated alternative text. The input of this step is the alternative character information from Step 16. The server repeats relevant data processing and classification operations, and the output of this step is a secondary risk classification result that verifies whether the degree of risk has been reduced to within acceptable bounds.

### Step 18:

The server prepares a response message containing risk information and alternatives. The server aggregates the original risk classification, the publication control decision, the alternative character information, and, if available, the secondary risk evaluation. The input of this step is the results from Steps 12, 13, 16, and optionally 17. The server formats this information into a compact response payload, and the output of this step is a structured message that can be transmitted to the terminal to inform the user.

### Step 19:

The terminal receives the response and presents options to the user. The terminal parses the response message, extracts the risk explanation, the alternative character information, and any publication control recommendations, and displays them on the user interface. The input of this step is the response payload from Step 18. The terminal performs user interface rendering operations, and the output of this step is a visual and interactive presentation by which the user can review risks and candidate alternative texts.

### Step 20:

The user selects whether to adopt the alternative character information. The user examines the displayed risk information and the generated alternative text and performs an operation on the terminal, such as pressing a button or selecting from a list, to indicate adoption, partial adoption, or rejection. The input of this step is the information displayed by the terminal in Step 19. The user's operation results in an adoption input signal, and the output of this step is a user decision captured by the terminal.

### Step 21:

The terminal sends the user's adoption input and final posting content to the server. The terminal packages the user's decision and, if applicable, the chosen alternative character information or a manually edited version, into a message and sends it to the server. The input of this step is the adoption decision and any modified text resulting from Step 20. The terminal performs message construction and transmission operations, and the output of this step is a control request received by the server indicating how the posting content should be finalized.

### Step 22:

The server updates the stored posting content and publication status according to the user's decision. The server reads the adoption input from the received message and, if alternative character information is adopted, replaces the stored original character information with the adopted text, updates numerical representations if needed, and sets the publication status based on the publication control decision. The input of this step is the user adoption information from Step 21 and the previously stored content from Step 3. The server executes database update operations and status transitions, and the output of this step is a persistent record of the finalized posting content and its publication state within the information sharing service.

### Application Example 1

Description follows regarding a flow of the specific processing in an Application Example 1. The units of the system described below are implemented by the data processing device 12 and the smart device 14. The data processing device 12 is called a “server” and the smart device 14 is called a “terminal”.

In online communication environments, social networking services allow users to rapidly publish multimodal content including text, images, and moving images. Conventional content moderation systems are typically configured to perform rule-based keyword filtering or simple classification on isolated text or images after the content has already been posted. Such systems suffer from several technical problems.

First, conventional systems generally perform content analysis using a single modality and a single model, without generating integrated feature information that jointly represents textual information and image information. As a result, such systems are unable to accurately capture nuanced interactions between linguistic expressions, visual elements, and user sentiment, and therefore cannot reliably estimate a flame risk, that is, a likelihood that a particular post will trigger an online backlash or reputational damage.

Second, existing approaches often evaluate risk using static thresholds and pre-defined patterns, without comparing current posting information against high-dimensional feature distributions derived from historical flame incidents. This prevents the system from efficiently reusing previously observed incident patterns and from quantitatively measuring similarity to those incidents in a scalable manner. In particular, conventional systems do not employ integrated feature vectors, similarity calculation algorithms, and a trainable flame-risk evaluation model in combination, and thus cannot adaptively improve risk estimation performance as more incident data becomes available.

Third, in many architectures, any form of recommendation or feedback to the user is generated by fixed templates on the client device or by simple server-side string substitution. Such techniques do not leverage generative artificial intelligence models guided by structured prompt sentences, and therefore cannot generate context-sensitive explanations or alternative posting suggestions that are tailored to the specific multimodal content and its evaluated flame risk. Because the generated feedback is generic, users receive limited technical guidance on how to modify their content, resulting in repeated posting of high-risk material and increased load on downstream moderation processes.

Fourth, a large portion of existing systems perform content analysis only after a post has been published. In these systems, client-server interaction is not designed to support a pre-publication feedback loop in which the server computes integrated feature information, compares that information with historical incidents, queries a generative artificial intelligence model by using a prompt sentence, and returns detailed warning information to the terminal device before the content is made public. This architectural limitation leads to increased consumption of network and storage resources related to the propagation and later removal or demotion of problematic content.

Accordingly, there is a need for a computer-implemented technique that improves the technical functioning of the server-side analysis pipeline itself by: (i) generating integrated feature information from textual and image information, (ii) comparing such integrated feature information with feature information stored in a flame-incident database by using a similarity calculation algorithm, (iii) evaluating a flame-risk index and a flame-risk category by using a trainable flame-risk evaluation model, and (iv) automatically constructing structured prompt sentences for a generative artificial intelligence model so as to generate explanation information and correction candidate information. By improving these internal computations and data flows, the server can provide real-time, pre-publication risk analysis and context-aware feedback to the terminal device, thereby reducing resource usage associated with downstream moderation and improving the overall robustness and reliability of the computer system that hosts the social networking service.

The specific processing by the specific processing unit 290 of the data processing device 12 in Application Example 1 is realized by the following means.

The present invention provides a server comprising a processor and a memory storing instructions that, when executed by the processor, cause the processor to receive, from a terminal device, posting information including textual information and image information; extract semantic feature information and sentiment feature information from the textual information by using a natural language processing algorithm; extract image feature information from the image information by using an image recognition algorithm; generate integrated feature information representing the posting information based on the semantic feature information, the sentiment feature information, and the image feature information; compare the integrated feature information with case feature information stored in a flame-incident database in association with historical posting information for which an online backlash has occurred; calculate a similarity between the integrated feature information and the case feature information by using a similarity calculation algorithm; calculate a flame-risk index and a flame-risk category by using a flame-risk evaluation model based on the similarity and the integrated feature information; determine that the flame-risk index or the flame-risk category exceeds a predetermined threshold; generate instruction information including a prompt sentence based on the posting information and the flame-risk index; input the instruction information to a generative artificial intelligence model so as to cause the generative artificial intelligence model to generate explanation information describing a flame risk associated with the posting information and correction candidate information including alternative posting information or alternative expression information that reduces the flame risk; acquire the explanation information and the correction candidate information output from the generative artificial intelligence model; generate warning information including at least part of the flame-risk index, the flame-risk category, the explanation information, and the correction candidate information; transmit the warning information to the terminal device to cause the terminal device to display the warning information so that a user is prompted to select modification of the posting information or cancellation of posting; and acquire, from the terminal device, selection operation information indicating the modification or the cancellation performed by the user and output control information regarding publication or restriction of publication of the posting information in accordance with the selection operation information. This enables an improvement in the operation of the computer system by providing an integrated, server-side pipeline that computes multimodal feature representations, performs similarity-based incident comparison and model-based flame-risk evaluation, and automatically generates structured prompt sentences for a generative artificial intelligence model, thereby achieving more accurate, adaptive, and resource-efficient pre-publication risk analysis and user feedback than can be obtained with conventional rule-based or unimodal moderation techniques.

The term “posting information” refers to data representing content that is intended to be published on a communication platform, including at least textual information and image information, and optionally additional metadata such as timestamps, user identifiers, or device information.

The term “textual information” refers to character-based data, such as sentences, phrases, or symbols, that are input by a user for inclusion in a post on a communication platform.

The term “image information” refers to data representing still or moving visual content, including but not limited to photographs, graphics, or frames extracted from video, which are attached to or included in a post.

The term “terminal device” refers to an end-user computing device, such as a smartphone, tablet, or personal computer, that executes an application or browser for composing, transmitting, and displaying posting information.

The term “semantic feature information” refers to numerical representation data derived from textual information that captures meanings, topics, or relationships among words or phrases, as computed by a natural language processing algorithm.

The term “sentiment feature information” refers to numerical representation data derived from textual information that captures emotional tone or attitude, such as positivity, negativity, or aggressiveness, as computed by a natural language processing algorithm.

The term “image feature information” refers to numerical representation data derived from image information that captures visual characteristics, such as shapes, patterns, objects, or scenes, as computed by an image recognition algorithm.

The term “integrated feature information” refers to numerical representation data that jointly encodes semantic feature information, sentiment feature information, and image feature information to represent multimodal characteristics of posting information.

The term “natural language processing algorithm” refers to a computational procedure executed by a computer to analyze, interpret, and transform human language data, including operations such as tokenization, embedding, classification, or sequence modeling.

The term “image recognition algorithm” refers to a computational procedure executed by a computer to analyze and interpret image information, including operations such as feature extraction, object detection, scene classification, or pattern recognition.

The term “flame-incident database” refers to a data storage structure that records historical posting information for which an online backlash has occurred, together with associated feature information, labels, or metadata describing the incidents.

The term “case feature information” refers to numerical representation data stored in the flame-incident database that represents characteristics of historical posting information for which an online backlash has occurred.

The term “similarity calculation algorithm” refers to a computational procedure that calculates a similarity or distance measure between integrated feature information and case feature information, using metrics such as cosine similarity or Euclidean distance.

The term “flame-risk index” refers to a numerical value output by a flame-risk evaluation model that indicates a degree of likelihood that posting information will cause an online backlash or reputational damage.

The term “flame-risk category” refers to a discrete classification label, derived from the flame-risk index or related inputs, that assigns posting information to qualitative levels of risk, such as low, medium, or high.

The term “flame-risk evaluation model” refers to a trainable computational model, such as a neural network or statistical classifier, that receives integrated feature information and related indicators as input and outputs at least a flame-risk index and optionally a flame-risk category.

The term “generative artificial intelligence model” refers to a machine learning model configured to generate new content, such as natural-language text, based on input data, which may include instructions, prompts, or context information.

The term “prompt sentence” refers to a sequence of natural-language text that is included in instruction information and that specifies a task or desired output for the generative artificial intelligence model, such as explanation of flame risk or generation of alternative expressions.

The term “instruction information” refers to data transmitted to the generative artificial intelligence model that includes at least one prompt sentence and may further include posting information, risk indicators, and other context necessary to cause the model to generate desired output information.

The term “explanation information” refers to natural-language text generated by the generative artificial intelligence model that describes reasons, factors, or context underlying the assessed flame risk of the posting information.

The term “correction candidate information” refers to data, including alternative posting information or alternative expression information, generated by the generative artificial intelligence model as suggested modifications intended to reduce flame risk.

The term “warning information” refers to data generated by the server and transmitted to the terminal device that includes at least part of the flame-risk index, the flame-risk category, and one or more of the explanation information and correction candidate information, and that is intended to prompt the user to reconsider or modify posting information.

The term “selection operation information” refers to data received from the terminal device that indicates a user's selection among options related to posting information, including at least modification, cancellation, or continuation of posting.

The term “control information regarding publication or restriction of publication” refers to data output by the server that specifies whether posting information is to be published, modified before publication, delayed, or subjected to access restrictions, based on selection operation information.

The term “online backlash” refers to a collective negative reaction expressed by a plurality of users on one or more communication platforms in response to posted content, including criticism, complaints, or reputational attacks.

The term “multimodal feature representation” refers to an integrated numerical representation that combines feature information derived from different types of input data, such as textual information and image information, into a single feature space for analysis.

In one or more embodiments, a server implements a flame-risk evaluation system by executing a program stored in a non-transitory computer-readable medium. The server includes at least one processor, a main memory, a network interface, and a storage device. The server communicates with a terminal operated by a user via a communication network. The server executes software components implemented, for example, on an operating system such as a server-grade operating system, and uses middleware such as a web application framework and an application server. The server exposes an application programming interface to the terminal so that the terminal can transmit posting information including textual information and image information.

The server uses a natural language processing stack based on a Transformer-type neural network implemented with a software library such as a deep learning framework (e.g., a transformer library executed on a tensor computation framework), and an image recognition stack based on a convolutional neural network implemented with a deep learning framework such as a tensor-based computation library. The server may further use a vector similarity search library to efficiently search a flame-incident database and a machine learning library to implement a flame-risk evaluation model. The server may also communicate with a remote or local generative AI model that accepts a prompt sentence and outputs natural-language text.

The server executes a program that, when run, causes the server to receive posting information from the terminal, generate multimodal feature representations, compare the feature representations with historical flame-incident data, evaluate a flame-risk index and a flame-risk category, construct prompt sentences for a generative AI model, and return warning information including explanation information and correction candidate information to the terminal.

In one embodiment, the server includes a text analysis module implemented using a Transformer-based language model. The server loads a pre-trained or fine-tuned language model consisting of multiple self-attention layers, feed-forward layers, layer normalization layers, and positional encoding structures. The server uses a tokenizer to split the textual information into subword units, convert the units into integer token IDs, and assemble them into fixed-length sequences with special tokens. The server places the resulting token ID tensors on a graphics processing unit or central processing unit optimized for parallel matrix operations.

The server computes semantic feature information by passing the token sequences through the Transformer model and extracting a contextual embedding corresponding to a special classification token or an averaged embedding over all tokens. The dimensionality of the embedding may be, for example, 256, 512, or 768. The server then computes sentiment feature information by applying a classification head, such as a fully connected neural network with non-linear activation functions, to the semantic embedding. The server outputs, for example, a sentiment polarity score, an aggressiveness score, and a toxicity score. These scores may be concatenated with the semantic embedding to form a text feature vector. The server stores the text feature vector in memory as a dense array of floating-point values for subsequent processing.

In another embodiment, the server includes an image analysis module implemented using a convolutional neural network such as a residual network or an efficient convolutional architecture. The server decodes image information received from the terminal into image tensors using an image processing library. The server resizes each image to a predetermined resolution, normalizes pixel values, and optionally applies data augmentation transformations during model training. During inference, the server passes the preprocessed image tensors through the convolutional neural network. The network includes convolution layers, pooling layers, activation layers, and a global average pooling layer to produce a compact feature vector representing the image. The server may further use a classification layer to output probabilities for categories such as “contains offensive symbol,” “contains violence,” or “contains mocking depiction.” The server stores the image feature vector as a dense numerical array.

The server generates integrated feature information by combining the text feature vector and the image feature vector. In one embodiment, the server concatenates the vectors and applies one or more fully connected layers with non-linear activation functions and dropout to reduce dimensionality and to learn interactions between textual and visual features. In another embodiment, the server uses an attention-based fusion network that takes text and image features as inputs and computes weighted combinations emphasizing modalities that are more relevant to flame risk. The resulting integrated feature information is a fixed-length vector that compactly represents the multimodal content of the posting information.

The server uses the integrated feature information to query a flame-incident database. The server maintains the flame-incident database in a storage device such as a relational database system, a document-oriented database, or a vector database. For each historical flame incident, the server stores case feature information that was computed by applying the same text analysis and image analysis modules as used for current postings. The server also stores labels or metadata such as severity of the incident, type of issue, and time of occurrence.

To perform similarity search, the server loads an index structure, for example, an approximate nearest neighbor index, into memory. The server computes similarity scores between the integrated feature information of the current posting information and the case feature information of historical incidents using a similarity calculation algorithm such as cosine similarity or Euclidean distance. The server selects one or more historical incidents with the highest similarity scores and aggregates similarity statistics, such as maximum similarity to severe incidents or average similarity to all incidents.

The server evaluates flame risk by using a flame-risk evaluation model. In one embodiment, the server implements the flame-risk evaluation model as a feed-forward neural network that receives the integrated feature information and similarity statistics as input. The network includes multiple dense layers with non-linear activation, batch normalization, and dropout.

The server trains this model on labeled data by minimizing a loss function such as cross-entropy for risk categories and mean squared error for risk index values. The server updates model weights using an optimization algorithm such as stochastic gradient descent or adaptive moment estimation. During inference, the server applies the trained model to the integrated feature information and similarity statistics to output a flame-risk index within a continuous range, such as 0.0 to 1.0, and a flame-risk category such as low, medium, or high. The server may periodically retrain or fine-tune the flame-risk evaluation model using newly collected data, thereby improving prediction accuracy over time.

The server determines whether the flame-risk index or flame-risk category exceeds a predetermined threshold. When the threshold is exceeded, the server prepares instruction information for a generative AI model. The server constructs a prompt sentence based on the posting information and the flame-risk index. In some embodiments, the server first summarizes the textual information and image content using lightweight models to reduce input length. The server then generates a prompt sentence that describes the task and includes key context. Example prompt sentences include:

“Analyze the following social media post and evaluate its flame risk (likelihood of causing strong public backlash or reputational damage). Then briefly explain the reasons and propose a revised version with lower flame risk, while preserving the main opinion. Post text: ‘This product is totally awful!’ Image description: ‘A meme image showing exaggerated anger and mocking the brand logo.’”

“Evaluate the flame risk of the following social media post and give a short explanation: ‘This product is totally awful!’”

“Rewrite the following post to reduce its flame risk while keeping the main message: ‘This product is totally awful!’”

“Given the following post text and a short description of the attached image, assess whether the post is likely to cause reputational damage or public backlash, and propose a safer alternative: [post text] [image description].”

The server transmits the prompt sentence, together with optional auxiliary parameters such as maximum output length or stylistic constraints, to the generative AI model. The generative AI model may be hosted on the same server, on a dedicated inference server including accelerator hardware, or on an external service accessible via an application programming interface.

The server receives response text from the generative AI model, including explanation information and correction candidate information. The explanation information may state, for example, that the post contains strong negative language, personal attacks, or implicit discriminatory statements, and may refer to specific phrases or visual motifs identified as contributing to flame risk. The correction candidate information may include one or more alternative phrasings that maintain the user's opinion while reducing inflammatory wording. The server may post-process the text by enforcing length constraints or adjusting formality level.

The server generates warning information that includes at least part of the flame-risk index, the flame-risk category, the explanation information, and the correction candidate information. The server transmits the warning information to the terminal via the network interface. The terminal displays the warning information in its user interface, for example in a dialog box above the posting editor. The user reads the warning information and selects an option, such as applying the suggested rewrite, modifying the post manually, canceling the post, or if permitted proceeding without modification. The terminal sends selection operation information to the server, and the server outputs control information indicating whether to publish the original posting information, publish the corrected posting information, or restrict publication.

This architecture provides several technical effects and advantages beyond mere automation of human review. Because the server computes integrated feature information using high-dimensional embeddings and similarity-based comparison, the server can discriminate subtle patterns and correlations that are not captured by simple keyword-based or rule-based systems. The use of a Transformer-based language model and a convolutional neural network allows the server to process large volumes of multimodal data in parallel, leveraging vectorized operations on specialized hardware. By indexing historical incidents in a vector database and performing approximate nearest neighbor search, the server reduces the computational burden of comparing new posts against a large incident corpus, thereby improving throughput and reducing latency in real-time evaluation.

Furthermore, the fusion of semantic feature information, sentiment feature information, and image feature information into a unified representation improves model accuracy by enabling the flame-risk evaluation model to exploit cross-modal dependencies. The similarity calculation algorithm and the trainable flame-risk evaluation model jointly implement a non-conventional analysis pipeline that adapts as new incident data is collected. This adaptive capability improves precision and recall in identifying high-risk posts and reduces false positives and false negatives.

The construction of structured prompt sentences and the use of a generative AI model also contribute to technical improvement. The server generates prompt sentences that encode, in a compact form, the essential attributes of the posting information and the associated flame-risk index. This targeted conditioning reduces unnecessary token usage and improves inference efficiency in the generative AI model. By integrating model outputs with internal risk evaluations, the server produces feedback that is directly aligned with internally computed feature representations and similarity scores, rather than relying on generic templates. This alignment leads to more technically coherent guidance that better reflects actual risk metrics.

From a system-level perspective, the server, terminal, and user interactions reduce downstream computation and storage associated with moderating already-published content. By intervening before publication, the server decreases the number of high-risk posts that propagate through the network, thereby reducing repeated retrieval and processing of harmful content by other moderation subsystems. The improved efficiency in multimodal feature computation and similarity search translates into lower average CPU and GPU usage per analyzed post, and thus into improved scalability.

In additional embodiments, the server varies the model architectures and processing procedures. For example, the server may use a bidirectional recurrent neural network instead of a Transformer in situations with constrained computational resources, or may employ a vision transformer instead of a convolutional neural network for image analysis. The server may also adjust dimensionality of feature vectors, similarity metrics, and network depth based on deployment requirements. The flame-incident database may be partitioned by language, region, or topic to further reduce search space and latency. The generative AI model may be fine-tuned on domain-specific corpora of safe and unsafe posts to produce explanations and rewrites with higher relevance.

The server may implement additional safeguards, such as confidence thresholds and ensemble models, to validate outputs from the flame-risk evaluation model and the generative AI model. The server may also maintain logs of integrated feature information, similarity results, risk indices, and generated texts for use in offline analysis and further model training. By structuring the entire processing pipeline in this way, the server improves the internal operation of the computer system itself, enhancing processing speed, classification accuracy, and resource utilization in a manner that is not achievable with conventional, purely rule-based moderation or manual human review.

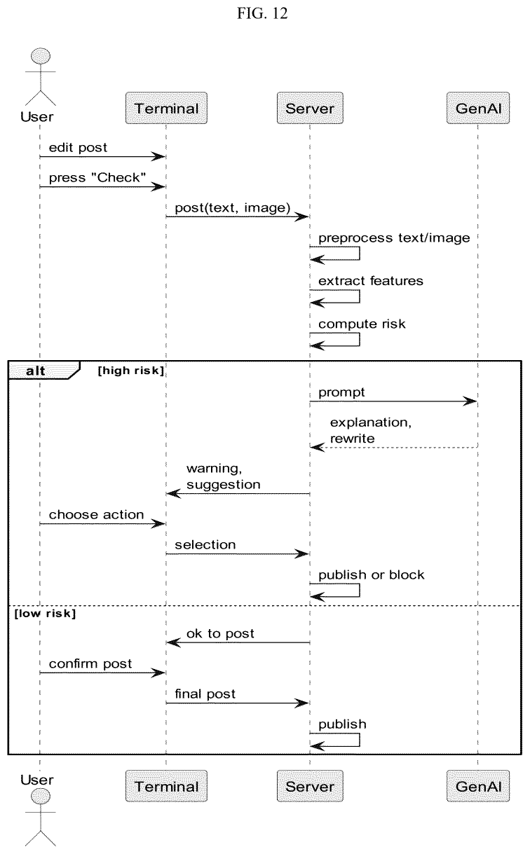

The following describes the processing flow using FIG. 12.

### Step 1:

Server receives posting information from the terminal.

Server uses a network interface to accept a request from the terminal that includes input data such as textual information, image information, user identifier, and timestamp.

Server parses the incoming request payload, for example a structured message, and converts the textual information to a character string object and the image information to raw binary image buffers. Server outputs validated posting information as an internal data structure that contains separate fields for text, images, and metadata, which are passed to subsequent analysis modules.

### Step 2:

Server preprocesses textual information.

Server receives as input the textual information from the posting information structure.

Server normalizes the text by converting it to a standard character encoding, removing control characters, optionally lowercasing or applying language-specific normalization, and splitting long text into manageable segments.

Server tokenizes the normalized text using a tokenizer associated with a Transformer-based language model, converting words and subwords into token identifiers and constructing fixed-length sequences with special tokens.

Server outputs tokenized text tensors representing the textual information, to be used as input to a natural language processing model.

### Step 3:

Server extracts semantic and sentiment feature information from the textual information.

Server receives as input the tokenized text tensors.

Server loads a Transformer-based neural network language model into memory and applies the model to the tokenized text, performing matrix multiplications and attention calculations to generate contextual embeddings for each token.

Server derives a sentence-level embedding by selecting a special classification token embedding or averaging token embeddings, and then applies a classification head to compute sentiment-related scores such as negativity, aggressiveness, or toxicity.

Server concatenates the sentence-level embedding and the sentiment-related scores to form a text feature vector.

Server outputs the text feature vector as dense numerical data representing semantic feature information and sentiment feature information.

### Step 4:

Server preprocesses image information.

Server receives as input the raw image buffers from the posting information structure.

Server decodes each buffer into an image matrix using an image processing library, adjusts color space if necessary, and resizes the image to a predefined resolution suitable for an image recognition model.

Server normalizes the pixel values, for example by scaling to a fixed numeric range and subtracting mean values, and optionally performs center-cropping or padding to maintain aspect ratio.

Server outputs preprocessed image tensors for each image, which serve as input to an image recognition neural network.

### Step 5:

Server extracts image feature information from the image information.

Server receives as input the preprocessed image tensors.

Server loads a convolutional neural network or similar visual model and forwards the image tensors through convolution, pooling, and activation layers to obtain intermediate activation maps.

Server applies a global pooling operation, such as global average pooling, to collapse the spatial dimensions and produce a compact feature vector for each image.

Server may further apply a classification layer to compute category probabilities for specific visual risk-related classes and append those probabilities to the feature vector.

Server aggregates feature vectors across multiple images associated with the same post, for example by averaging them, to obtain a single image feature vector.

Server outputs the image feature vector as dense numerical data representing image feature information.

### Step 6:

Server generates integrated feature information.

Server receives as input the text feature vector and the image feature vector.

Server concatenates these vectors into a single combined vector and optionally applies one or more fully connected layers with non-linear activation and dropout to learn cross-modal interactions and reduce dimensionality.

Server may normalize the resulting vector using techniques such as batch normalization or L2 normalization to stabilize downstream similarity computations.

Server outputs an integrated feature vector, which constitutes integrated feature information representing multimodal characteristics of the posting information.

### Step 7:

Server retrieves case feature information from a flame-incident database.

Server receives as input the integrated feature vector for the current posting information.

Server queries a storage system that holds case feature information corresponding to historical flame incidents, optionally filtering by language, region, or topic based on metadata of the current posting.

Server loads relevant case feature vectors and associated labels into memory, either directly from the database or via a pre-built similarity index structure.

Server outputs a set of case feature vectors and associated metadata to be used in similarity calculation.

### Step 8:

Server calculates similarity between the integrated feature information and the case feature information.

Server receives as input the integrated feature vector and the set of case feature vectors.

Server computes similarity metrics such as cosine similarity or Euclidean distance for each pair consisting of the integrated feature vector and a case feature vector, using vectorized operations to reduce computation time.

Server identifies top-ranked similar cases based on the similarity metrics and aggregates statistics such as maximum similarity, average similarity, and similarity distribution by severity level.

Server outputs similarity statistics and identifiers of the most similar historical flame incidents.

### Step 9:

Server evaluates a flame-risk index and a flame-risk category.

Server receives as input the integrated feature vector and the similarity statistics.

Server feeds these inputs into a flame-risk evaluation model, such as a feed-forward neural network that has been trained on labeled data of past posts and their flame outcomes. Server performs a forward pass through the model, applying learned weights and activation functions to compute a continuous flame-risk index and a probability distribution over discrete risk levels.

Server selects the most probable risk level as the flame-risk category and may apply calibration or thresholding to refine the index and category.

Server outputs the flame-risk index and the flame-risk category as numerical and categorical risk indicators.

### Step 10:

Server determines whether to invoke a generative AI model based on the flame-risk index and the flame-risk category.

Server receives as input the flame-risk index and the flame-risk category.

Server compares these values to predefined thresholds, for example determining that medium and high categories or indices above a certain numeric threshold require explanation and suggestion generation. Server outputs a decision flag indicating whether further generative processing is required and passes along the associated posting information and risk indicators.

### Step 11:

Server constructs a prompt sentence for the generative AI model.

Server receives as input the posting information, the flame-risk index, the flame-risk category, and the decision flag indicating that generative processing is required.

Server may first summarize long textual information and describe image content using existing analysis results, then embeds this context into a natural-language instruction.

Server composes a prompt sentence that specifies the analysis objective, the content to be evaluated, and the required outputs such as explanation of risk and safer rephrasing.

Server generates, for example, a prompt sentence such as:
“Analyze the following social media post and evaluate its flame risk (likelihood of causing strong public backlash or reputational damage). Then briefly explain the reasons and propose a revised version with lower flame risk, while preserving the main opinion. Post text: ‘This product is totally awful!’ Image description: ‘A meme image showing exaggerated anger and mocking the brand logo.’”

Server outputs the constructed prompt sentence and associated parameters as instruction information for the generative AI model.

### Step 12:

Server obtains explanation information and correction candidate information from the generative AI model.

Server receives as input the prompt sentence and any additional instruction information.

Server sends this information to the generative AI model via an interface, waits for completion of inference, and receives generated natural-language text as output.

Server parses the output to separate explanation information, which describes why the content is risky, from correction candidate information, which contains one or more suggested alternative expressions.

Server outputs the explanation information and correction candidate information as structured text data for integration into a warning message.

### Step 13:

Server generates warning information for the terminal.

Server receives as input the flame-risk index, the flame-risk category, the explanation information, and the correction candidate information.

Server formats these elements into a warning structure that may include numeric risk indicators, textual risk labels, a concise explanation, and at least one suggested rewrite of the posting information.

Server may truncate overly long messages or prioritize the most relevant explanation and suggestion according to internal ranking rules.

Server outputs the warning information, ready for transmission to the terminal.

### Step 14:

Server transmits warning information, and terminal displays it to the user.

Server receives as input the warning information and the identifier of the target terminal.

Server sends the warning information over the network to the terminal using a communication protocol.

Terminal receives the warning information, parses the content, and updates the user interface to display the risk level, explanation, and suggested alternative expressions in association with the posting editor.

Terminal outputs a visual display that enables the user to understand the assessed flame risk and possible modifications.

### Step 15:

User selects an action in response to the warning information.

User views the warning information on the terminal display and, based on the explanation and correction candidate information, decides whether to accept a suggested rewrite, manually edit the post, cancel posting, or proceed without modification if allowed.

User operates one or more user interface elements, such as buttons or text fields, to indicate the chosen action.

Terminal captures the user's selection as selection operation information and outputs this selection operation information to the server.

### Step 16:

Server controls publication or restriction of publication based on the user's selection.

Server receives as input the selection operation information from the terminal.

Server interprets the selection, determining whether to publish the original posting information, publish modified posting information incorporating the correction candidate information, delay or cancel publication, or apply additional restrictions such as limiting visibility to certain audiences.

Server generates control information that indicates the final publication state and, if applicable, updates the stored posting information to a corrected version.

Server outputs the control information to a backend content management system, which handles actual storage and dissemination of the post according to the specified publication or restriction conditions.

It is also possible to incorporate an emotion engine for estimating the user's emotions. That is, the specific processing unit 290 may estimate the user's emotions using an emotion identification model 59, and perform specific processing based on the estimated emotions.

### Example 2

Description follows regarding a flow of the specific processing in an Example 2. The units of the system described below are implemented by the data processing device 12 and the smart device 14. The data processing device 12 is called a “server” and the smart device 14 is called a “terminal”.

Conventional content moderation and risk management techniques for online information sharing services rely heavily on static keyword filters, manual review, or generic machine learning models that are not tightly integrated into the end-to-end posting workflow. These approaches suffer from several technical limitations.

First, conventional systems typically treat risk detection and content rewriting as separate, loosely coupled processes. A risk scoring module may flag content as problematic, but it does not automatically generate tailored, context-aware rewrite instructions for a generative AI model. As a result, the system either blocks content outright or forces a human operator or end user to manually rephrase the content, which introduces latency, inconsistency, and additional computational and communication overhead.

Second, existing systems often use simple keyword matching or coarse sentiment analysis to detect potentially inflammatory content. Such approaches fail to accurately account for semantic similarity to past incidents that actually resulted in large-scale negative reactions. Without a robust mechanism to compute and compare embedding representations of new posts and historical flaming cases, the system cannot precisely quantify a flaming risk index. This leads to high false positive and false negative rates, and degrades the technical performance of automated risk management, including unnecessary suppression of benign content and insufficient control of truly risky content.

Third, even when a generative AI model is used, many systems employ static or generic prompts that are not dynamically customized based on the risk level or detailed analysis results for a particular post. This leads to sub-optimal use of computational resources, because the generative AI model may generate overly conservative or irrelevant suggestions that require further manual editing. In addition, the lack of feedback from post-generation risk re-evaluation prevents the system from closing the loop and adjusting downstream actions (such as recommending temporary stop or cancellation of posting) in a systematic and automated manner.

Fourth, conventional architectures often perform risk detection and rewriting suggestions in an ad-hoc manner at the user interface, without a server-side architecture that consistently applies structured preprocessing, structured data generation, semantic embedding, database search, and prompt

generation logic. This fragmentation makes it difficult to scale the system, to optimize processing pipelines, and to ensure predictable latency and throughput as the number of users and posts increases.

Accordingly, there is a need for a system and server-side processing technique that improves computer functionality by: (i) transforming unstructured character information into structured analysis result data, (ii) computing semantic representations and embedding representations to accurately quantify flaming risk through similarity to stored historical cases, (iii) dynamically generating and customizing prompt sentences for a generative AI model based on the computed flaming risk index and analysis results, and (iv) re-evaluating alternative character information generated by the generative AI model and automatically determining whether to recommend temporary stop or cancellation of posting. Such a system should reduce computational inefficiencies, improve the accuracy and reliability of automated flaming risk assessment, and enhance the technical robustness of content handling in information sharing services.

The specific processing by the specific processing unit 290 of the data processing device 12 in Example 2 is realized by the following means.

The present invention provides a server comprising a processor configured to receive character information transmitted from a terminal device to an information sharing service, perform preprocessing on the character information, and store the preprocessed character information as structured data; apply a language analysis algorithm to the structured data to calculate emotion information and harmfulness information, extract feature values from the structured data, and generate analysis result data; generate a semantic representation of the character information based on the analysis result data, search a stored flaming case database for similar cases by using the semantic representation, calculate a flaming risk index by integrating similarity to the similar cases and the analysis result data, and classify the flaming risk index into a plurality of risk levels; when the flaming risk index is determined to be equal to or higher than a predetermined level, generate a prompt sentence, based on the character information and a rewriting policy corresponding to the flaming risk index, for input to a generative AI model, and input the prompt sentence to the generative AI model to cause the generative AI model to generate alternative character information for reducing flaming risk; re-evaluate the alternative character information generated by the generative AI model based on the flaming risk index and determine a final flaming risk level for the alternative character information; and, when the final flaming risk level exceeds a predetermined threshold, generate control information for recommending a temporary stop or cancellation of publication or transmission of a corresponding post to a user, and transmit the alternative character information and the control information to the terminal device for display. This enables the server to technically improve automated flaming risk management by transforming unstructured input into structured analysis data, accurately quantifying risk through semantic and embedding-based comparison with historical cases, dynamically generating and customizing prompt sentences for a generative AI model according to the computed risk, and closing the loop through re-evaluation of generated alternative content and automatic recommendation of posting control, thereby reducing processing inefficiencies, lowering error rates in risk detection, and enhancing the overall reliability and scalability of content handling in information sharing services.

The term “character information” refers to digital information representing textual content composed of characters, symbols, or punctuation, which is transmitted from a user's terminal device to an information sharing service as a candidate post or message.

The term “terminal device” refers to an electronic apparatus operated by a user, such as a computing device or communication device, that is configured to transmit character information to a server and to receive and display information returned from the server.

The term “information sharing service” refers to an online service or platform that enables multiple users to create, transmit, publish, and view posts or messages, including but not limited to social networking services, bulletin boards, or messaging services.

The term “preprocessing” refers to a series of computational operations applied to received character information to normalize and prepare it for analysis, including at least one of trimming whitespace, normalizing character encoding, segmenting sentences, tokenizing text, and converting the character information into structured data.

The term “structured data” refers to data derived from character information that has been organized into a predefined format or schema, such as records, fields, or keyed elements, so that the data can be efficiently processed by algorithms for analysis and storage.

The term “language analysis algorithm” refers to a computational procedure or model that processes structured data representing character information to derive linguistic or semantic attributes, including at least one of grammatical features, sentiment values, or topic indicators.

The term “emotion information” refers to data that quantitatively or qualitatively represents an inferred emotional state or attitude expressed in the character information, such as positive, neutral, negative, or more fine-grained emotional categories with associated scores.

The term “harmfulness information” refers to data indicating a degree or type of potential harm associated with the character information, including but not limited to toxicity, insult, hate, threat, or other risk-relevant categories, each optionally expressed as a probability or score.

The term “feature values” refers to numerical or categorical values extracted from structured data that represent characteristics of the character information, such as word frequencies, presence of specific expressions, syntactic patterns, sentiment scores, or embedding components, which are used as inputs to subsequent computational processes.

The term “analysis result data” refers to data obtained from applying a language analysis algorithm and feature extraction to structured data, including emotion information, harmfulness information, and feature values, and serving as an intermediate representation for risk evaluation and further processing.

The term “semantic representation” refers to a representation of the meaning or content of character information, derived from analysis result data, which allows comparison of different pieces of content at a semantic level rather than at a simple keyword or surface level.

The term “flaming case database” refers to a data storage structure that holds records of historical posts or messages that have been identified as having caused or contributed to significant online controversy, each record including at least the content, associated labels, and one or more semantic or embedding representations.

The term “similar cases” refers to records retrieved from the flaming case database whose semantic or embedding representations are determined, according to a similarity metric, to be close to the semantic representation of newly received character information.

The term “flaming risk index” refers to a numerical or categorical indicator that represents an estimated likelihood or severity of the character information causing online flaming, calculated by integrating similarity to similar cases with analysis result data and optionally other derived metrics.

The term “risk levels” refers to discrete categories into which the flaming risk index is classified, such as low, medium, high, or very high, each category indicating a relative magnitude of flaming risk.

The term “rewriting policy” refers to a set of rules or parameters that define how character information should be modified in order to reduce flaming risk, including constraints on tone, degree of criticism, politeness, and inclusion or exclusion of certain expressions, and which is selected or adjusted based on the flaming risk index.

The term “prompt sentence” refers to a text string that contains instructions, constraints, and context information, including at least a portion of the character information and a rewriting policy, which is provided as input to a generative AI model to control and guide the generation of alternative character information.

The term “generative AI model” refers to a machine learning model configured to generate new textual content in response to an input prompt sentence, typically by predicting sequences of tokens based on learned patterns from training data, and usable for rewriting or transforming character information.

The term “alternative character information” refers to textual content generated by the generative AI model in response to a prompt sentence, which is intended to express the substance of the original character information with a reduced flaming risk according to the rewriting policy.

The term “re-evaluate” refers to performing a risk assessment process on alternative character information that is analogous to or derived from the risk assessment applied to the original character information, in order to determine a final flaming risk level for the alternative character information.

The term “final flaming risk level” refers to a risk level assigned to alternative character information after re-evaluation, which is used as the basis for determining whether to recommend control actions such as temporary stop or cancellation of posting.

The term “control information” refers to information generated by the server that indicates a recommended action regarding publication or transmission of a post, including at least one of a recommendation for temporary stop, delay, modification, or cancellation, and optionally includes explanatory text for the user.

In one embodiment, a server cooperates with one or more terminal devices operated by users to evaluate and reduce flaming risk for character information transmitted to an information sharing service. The server includes at least one processor, a main memory, a nonvolatile storage unit, and one or more network interfaces. The server is connected, via a communication network such as the Internet, to terminal devices that may be implemented as smartphones, tablet computers, or personal computers. Each terminal device executes a client application or web browser and provides a graphical user interface for inputting, transmitting, and displaying character information and related feedback.

The server executes an application program implemented, for example, in a programming language such as Python or another general-purpose language, on top of an operating system such as a generic server operating system. The server may use a web framework such as a generic asynchronous web framework to handle HTTP requests from the terminal devices.

The server may also use a data management system such as a relational database system to store structured data, analysis result data, flaming case records, and various configuration parameters. The server may use a logging system such as a distributed log collector and viewer to record processing events and performance metrics.

The server uses specific software modules and data structures to implement the claimed functionality. The server includes a preprocessing module, a language analysis module, a semantic embedding module, a risk evaluation module, a prompt generation module, a generative AI interface module, and a re-evaluation and control module. These modules may be implemented as separate software components or as logically distinct functions within one or more executable programs.

The server stores, in the nonvolatile storage unit, a flaming case database. The flaming case database includes a plurality of records, each record comprising at least: (i) historical character information that has been associated with an occurrence of online flaming; (ii) one or more labels indicating a severity level or category of the flaming incident; (iii) a semantic embedding vector representing the content of the historical character information; and (iv) additional metadata such as timestamps or platform identifiers. The semantic embedding vector may, for example, have a fixed dimensionality such as 384, 512, or 768 dimensions, and may be stored as an array of floating-point values.

The server uses a natural language processing library, such as a general-purpose NLP toolkit, for tokenization, sentence segmentation, and part-of-speech tagging. The server uses one or more pretrained language models, such as transformer-based models provided by a model library, to compute sentiment scores, harmfulness scores, and semantic embeddings. The server also uses a generative AI model, which may be an autoregressive transformer model, a sequence-to-sequence transformer model, or another text generation architecture, accessible either via a remote model serving API or via a locally hosted model execution environment. The server loads model parameters for the sentiment and harmfulness classifier models. These models may be implemented as multi-layer transformer encoders with a final classification head. Each model includes an embedding layer that maps tokens to vector representations, a plurality of transformer layers comprising self-attention sublayers and feed-forward sublayers, and an output layer that maps the encoder output to probability scores for sentiment classes such as positive, neutral, and negative, and harmfulness classes such as toxic, non-toxic, insult, or hate. The server also loads a sentence embedding model, which may share a similar architecture but uses a pooling operation, such as mean pooling or attention pooling, over token embeddings to produce a fixed-length sentence-level vector.

The server trains, or pre-loads, these models using supervised or unsupervised learning methods. In one embodiment, the server uses a training dataset of text samples labeled with sentiment and harmfulness categories and optimizes a cross-entropy loss function using a gradient-based optimizer such as stochastic gradient descent or Adam. The server updates model weights based on backpropagation to minimize the loss. For the sentence embedding model, the server may use a contrastive learning objective, such as a triplet loss or a cosine similarity loss between positive and negative pairs, to encourage semantically similar sentences to have closer embedding vectors. Data augmentation methods such as synonym replacement, random deletion, or back-translation may be used during training to improve robustness and generalization.

The server uses a generative AI model with a neural network architecture that includes a token embedding layer, multiple transformer decoder layers with multi-head self-attention and position-wise feed-forward networks, and an output projection layer followed by a softmax layer that yields a probability distribution over possible next tokens. The generative AI model is trained on large-scale text corpora using a language modeling objective, where the loss function is typically the negative log likelihood of the correct next token given the previous tokens. During fine-tuning for rewriting tasks, the server may use datasets of pairs of original and rewritten, safer content, and adopt a supervised fine-tuning objective that encourages the model to generate text similar to the safer content when prompted with instructions and original content.

The server uses specific data structures when processing character information. The server represents each received post as a record that includes fields such as: an identifier, a user identifier, original character information, a timestamp, a language code, one or more sentiment scores, one or more harmfulness scores, a set of feature values, a semantic embedding vector, and a flaming risk index. The server may store these records temporarily in memory during processing, and may archive selected parts to the relational database for later analysis or model improvement.

The server uses particular algorithms and heuristics that differ from conventional human manual moderation. For example, the server applies a non-linear mapping from sentiment and harmfulness scores to intermediate risk features, uses threshold logic combined with similarity scores to historical flaming cases, and employs explicit rewriting policies encoded as machine-readable rules. These rules may include constraints such as: limit the number of negative adjectives per sentence, replace absolute expressions like “totally useless” with relative expressions like “did not meet my expectations,” and ensure the inclusion of at least one neutral or positive phrase where possible. The server applies these rewriting policies when constructing prompt sentences, thereby driving the generative AI model to follow domain-specific and risk-aware behavior that a generic human editor would not systematically and consistently adopt.

The server uses the semantic embedding module to compute an embedding vector for each piece of new character information. The server passes tokenized text through the embedding model, obtains token-level embeddings, and performs a pooling operation to produce a fixed-length vector. The server then uses a similarity calculation, such as cosine similarity, between this vector and the stored embedding vectors in the flaming case database. To accelerate this process, the server may use a vector index structure, such as a tree-based or graph-based approximate nearest neighbor index, so that similarity search can be performed in sub-linear time with respect to the number of stored cases. This reduces computational load and latency compared to a naive linear search, thereby improving processing speed.

The server uses the risk evaluation module to integrate multiple indicators: sentiment scores, harmfulness scores, similarity scores to past cases, and derived feature values such as presence of named entities or absolute terms. The server may implement this integration as a logistic regression model or a small feed-forward neural network with one or more hidden layers and non-linear activation functions such as ReLU. The server inputs the feature vector into the risk evaluation model to obtain a flaming risk index in a range such as 0.0 to 1.0. The server then maps this index to discrete risk levels, such as low, medium, high, or very high, using predefined threshold values stored in configuration parameters. This numeric and algorithmic integration allows precise and repeatable risk estimation even under high traffic, which is difficult for human moderators.

The server uses the prompt generation module to convert analysis results into a prompt sentence suitable for controlling the generative AI model. The server stores, in memory or in configuration files, a plurality of prompt templates associated with different risk levels and content types. Each template may include fixed instruction text and placeholders for inserting the original character information and specific constraints. For example, when the risk level is high for a product review, the server may select a template such as:
“You are a writing assistant that reduces the risk of online flaming. Rewrite the following post into constructive feedback. Keep the original intention but avoid insulting or extreme expressions, and include at least one positive or neutral aspect if possible. Post: ‘[ORIGINAL_TEXT]’”

The server replaces “[ORIGINAL_TEXT]” with the original character information to produce a concrete prompt sentence. The server may vary the instruction text based on the type of harmfulness detected, for example by adding explicit instructions to remove personal attacks when insults are detected, or to avoid group-based statements when hate-related language is detected. The server thus customizes the prompt sentence based on numeric risk indices and analysis result data, rather than using a static generic prompt, which leads to more accurate and efficient use of the generative AI model.

The server uses the generative AI interface module to send the prompt sentence to the generative AI model. If the generative AI model is provided as a remote service, the server formats an API request that includes the prompt sentence and model parameters such as maximum output length, temperature, and stopping conditions, and transmits the request via the network interface. If the generative AI model is hosted locally, the server provides the prompt sentence to a local inference engine that manages GPU resources such as a general-purpose GPU for fast matrix multiplications. In either case, the server processes the model output token by token and assembles the tokens into the alternative character information.

The server applies re-evaluation to the alternative character information using a similar or simplified version of the risk evaluation process. The server passes the generated text to the language analysis module to obtain updated sentiment and harmfulness scores, recalculates or approximates the semantic embedding, and derives a second flaming risk index. The server compares this index to specified thresholds and determines a final flaming risk level. If the final risk level remains above a high threshold, the server may choose to generate an additional prompt sentence that requests an even softer or more neutral rewriting, or may decide that the risk cannot be sufficiently mitigated and construct control information recommending that the user not publish the post.

The server transmits, via the network interface, the alternative character information and the control information to the terminal device in a structured response message. The control information may specify, for example, that posting is not recommended, that posting should be delayed, or that the user is advised to review the content carefully. The terminal device displays the alternative character information in an editable text field and displays the control information as a notification, banner, or icon. The user may then choose to adopt the alternative character information, modify it manually, or cancel the post.

The terminal device, in one embodiment, executes a client application that sends the user's original character information to the server and receives the alternative character information and control information. The terminal device updates the user interface to show both the original and alternative content, optionally highlighting differences. The terminal device may provide dedicated buttons such as “Use suggested text,” “Edit further,” or “Cancel,” thereby enabling efficient user interaction. The terminal device may also send telemetry data back to the server, such as whether the user accepted or rejected the suggestion, which can be used in non-real-time to improve model training and prompt templates.

The described implementation produces several technical effects that go beyond a mere automation of human moderation. By transforming unstructured character information into structured analysis result data and semantic embedding vectors, the server improves the internal representation and data management of textual content, which in turn allows efficient indexing and retrieval in the flaming case database. By integrating a multi-dimensional risk evaluation model and embedding-based similarity search, the server improves accuracy and reduces false positive and false negative rates compared to simple keyword filters, which is a technical improvement in the field of automated content analysis.

By using prompt sentences that are dynamically generated based on risk levels and analysis features, the server reduces the number of generative AI calls needed to achieve an acceptable risk level and decreases the average length of generated outputs, thereby reducing computational load and network traffic. This improves overall processing speed and resource utilization. The re-evaluation loop ensures that only suggestions with sufficiently low risk are presented, which minimizes the need for repeated interactions between the terminal device and the server, thus decreasing communication overhead.

Because the server uses specific algorithms such as transformer-based sentence embeddings, approximate nearest neighbor search, logistic regression or neural network-based risk scoring, and rule-based prompt template selection, the system follows machine-executable, non-intuitive procedures that are different from those used by human moderators. Human moderators typically review content in a serial and subjective manner without computing high-dimensional semantic embeddings or numeric similarity to thousands of historical cases within milliseconds. In contrast, the server exploits the parallel computation capabilities of CPUs and GPUs, optimized data structures for vector search, and systematic application of rewriting rules encoded into prompt sentences, thereby achieving objective, repeatable, and scalable behavior that constitutes an improvement to computer technology itself.

In another embodiment, the server may use different model architectures or algorithms while maintaining the core concept. For example, the server may replace the transformer-based sentimental classifier with a recurrent neural network or a convolutional neural network classifier, or may use a different type of embedding model such as a dual-encoder architecture trained with a contrastive loss. The flaming case database may be implemented using a graph database instead of a relational database, with nodes representing cases and edges representing similarity relationships, so that the server can perform graph-based propagation of risk scores. The risk evaluation module may employ decision trees, random forests, or gradient-boosted decision trees instead of logistic regression, depending on computational constraints and desired interpretability.

In yet another embodiment, the server may operate entirely within a local network, for use in an enterprise information sharing system. In this case, all models, databases, and processing modules reside on-premises, and the communication between the server and the terminal devices occurs within the enterprise network. This configuration may enable lower latency and stronger data privacy, while still benefiting from the same technical advantages of embedding-based risk estimation and prompt-driven rewriting using a generative AI model. In all embodiments, the server, terminal, and user collectively form a technical system in which the server performs structured, algorithmic processing of character information using specific hardware and software configurations, data structures, and neural network models.

This structured processing yields improvements in processing speed, accuracy, scalability, and resource utilization that are not attainable through manual human moderation or naive automation, and thus constitutes a concrete technological implementation rather than an abstract idea.

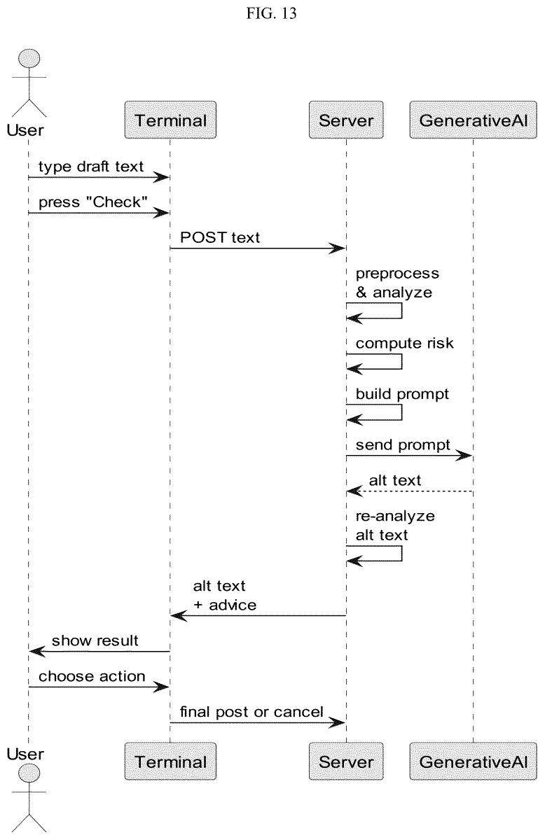

The following describes the processing flow using FIG. 13.

### Step 1:

User inputs draft character information on the terminal.

User operates the terminal to open an input screen of an information sharing service and types draft character information, such as “This product is totally useless!”.

Input: User's keystrokes and touch operations on the terminal.

Output: A text string displayed in an input field on the terminal.

Terminal converts individual keystrokes into a Unicode text buffer, updates the display in real time, and maintains the current text as an internal variable ready to be transmitted to the server.

### Step 2:

Terminal transmits the draft character information to the server.

User presses a button such as “Check risk” or “Preview” on the terminal.

Input: The text string stored in the terminal's input field.

Output: An HTTP request containing the text string as payload, sent to the server.

Terminal constructs a request object, for example an HTTP POST with a JSON body including a field “text”, serializes the text string into the body, adds headers such as content type and authentication tokens, and sends the request via a network stack to the server's network address.

### Step 3:

Server receives and parses the request from the terminal.

Server accepts the incoming HTTP request through a web server component and passes it to an application handler.

Input: A raw HTTP request message containing headers and a JSON body.

Output: An internal representation of the request, including an extracted text string.

Server decodes the HTTP message, parses headers, reads the body, decodes the JSON structure, and maps the value of the “text” field to an internal variable representing the original character information.

### Step 4:

Server performs preprocessing and converts the text into structured data.

Server applies normalization procedures to the received text.

Input: The original character information string.

Output: A structured data object containing normalized text and related metadata.

Server removes leading and trailing whitespace, collapses multiple spaces, normalizes character encoding to a standard such as UTF-8, segments the text into sentences using a language processing library, and constructs a data object containing fields such as original_text, sentences, language code, and timestamp.

### Step 5:

Server executes language analysis to compute emotion and harmfulness information.

Server runs a sentiment and harmfulness classifier on the structured text.

Input: The structured data object containing normalized text and sentences.

Output: Analysis result data including emotion information, harmfulness information, and intermediate features.

Server tokenizes the text into tokens using a tokenizer of a language model, converts tokens to numerical IDs, feeds the sequence of IDs into a neural network classifier, computes forward passes through embedding layers and transformer layers, obtains class probabilities, and aggregates probabilities into scores such as sentiment_score and toxicity_score.

### Step 6:

Server extracts feature values and augments the analysis result data.

Server derives explicit feature values that represent risk-related properties of the text.

Input: The structured data object and raw classifier outputs.

Output: An extended analysis result data structure containing feature values.

Server inspects the text to detect occurrences of absolute terms, insults, or sensitive phrases, converts such detections into binary or numeric features, combines these with sentiment and harmfulness scores into a feature vector, and stores the feature vector in the analysis result data.

### Step 7:

Server generates a semantic embedding representation.

Server computes an embedding vector that represents the meaning of the text.

Input: The structured data object containing the normalized text.

Output: A fixed-length semantic embedding vector associated with the text.

Server tokenizes the text again using an embedding model's tokenizer, maps tokens to embeddings, passes them through a stack of transformer layers, aggregates the final layer token embeddings using a pooling operation such as mean pooling, and outputs the resulting vector as the semantic representation.

### Step 8:

Server searches the flaming case database for similar cases.

Server compares the new embedding to stored embeddings of historical flaming cases.

Input: The semantic embedding vector and stored embedding vectors in the flaming case database.

Output: A list of similar cases with similarity scores.

Server uses a vector index to perform approximate nearest-neighbor search, calculates similarity metrics such as cosine similarity between the new embedding and stored embeddings, selects top-k most similar records, and retrieves their associated risk labels and metadata.

### Step 9:

Server calculates a flaming risk index and assigns a risk level.

Server integrates analysis results and similarity information into a numeric risk measure.

Input: The feature vector from the analysis result data and similarity scores from similar cases.

Output: A flaming risk index and a corresponding categorical risk level.

Server concatenates feature values and similarity scores into a single feature vector, feeds this vector into a risk evaluation model such as a logistic regression or small neural network, computes a scalar output between 0 and 1 representing risk, and compares this scalar to predefined thresholds to classify the risk level as low, medium, high, or very high.

### Step 10:

Server determines whether to invoke the generative AI model.

Server makes a decision based on the calculated flaming risk index.

Input: The flaming risk index and risk level.

Output: A control flag indicating whether to generate alternative character information.

Server compares the risk level against configured thresholds, sets a flag such as need_rewrite to true when the risk level is medium or higher, and stores this decision in a processing context that is carried to subsequent modules.

### Step 11:

Server selects or constructs a rewriting policy.

Server chooses a set of constraints and targets for rewriting based on the risk analysis.

Input: The risk level, feature vector, and analysis result data.

Output: A rewriting policy object containing rule parameters.

Server inspects detected harmfulness categories and sentiment strength, assigns rewriting rules such as removing insults, softening absolute expressions, and injecting neutral or positive elements, encodes these rules as parameters including allowed sentiment range and banned phrase patterns, and stores them in the rewriting policy object.

### Step 12:

Server generates a prompt sentence for the generative AI model.

Server converts the rewriting policy and original text into an instruction string.

Input: The original character information and the rewriting policy.

Output: A complete prompt sentence to be sent to the generative AI model.

Server selects a template corresponding to the risk level and content type from a stored template set, inserts the original text into a placeholder, adds constraints such as language and tone, and constructs a prompt sentence such as:
“You are a writing assistant that reduces the risk of online flaming. Rewrite the following post into constructive feedback. Keep the original intention but avoid insulting or extreme expressions, and include at least one positive or neutral aspect if possible. Post: ‘This product is totally useless!’”

Server then stores this prompt sentence in the processing context.

### Step 13:

Server transmits the prompt sentence to the generative AI model. Server initiates a generation request using the prepared prompt.

Input: The prompt sentence and generation parameters.

Output: A model query submitted to a generative AI execution environment.

Server formats an inference request, including the prompt sentence, maximum output length, sampling parameters such as temperature, and safety-related settings, and sends the request either to a remote model API over the network or to a local inference engine running on a processor and a graphics processor.

### Step 14:

Server receives generated alternative character information from the generative AI model.

Server collects the output tokens and assembles them into text.

Input: A sequence of tokens or a text string produced by the generative AI model.

Output: Alternative character information in text form.

Server reads the response stream or message, decodes token IDs back to characters using the model's vocabulary, concatenates the tokens into a coherent string, trims trailing whitespace or incomplete fragments, and stores the resulting string as the alternative character information.

### Step 15:

Server performs re-evaluation of the alternative character information.

Server applies a secondary risk assessment to verify that risk is reduced.

Input: The alternative character information string.

Output: A final flaming risk level associated with the alternative character information.

Server repeats a simplified version of the language analysis, feature extraction, and risk evaluation: tokenizing the alternative text, computing updated sentiment and harmfulness scores, optionally recomputing an embedding, feeding the new feature vector into the risk evaluation model, obtaining a new flaming risk index, and mapping it to a final risk level.

### Step 16:

Server generates control information for posting recommendations.

Server determines whether to recommend posting, modification, or cancellation.

Input: The final flaming risk level and the original risk level.

Output: Control information describing recommended user actions.

Server compares the final risk level to a high-risk threshold, generates text such as “Posting is still highly risky; we recommend not posting this content” when the level remains high, or generates text such as “Risk has been reduced to an acceptable level; you may post this content” when the level is low. Server encapsulates this guidance together with flags indicating recommend_stop or recommend_post in a control information object.

### Step 17:

Server transmits the alternative character information and control information to the terminal.

Server prepares a response message for presentation to the user.

Input: The alternative character information and the control information object.

Output: A structured response sent over the network to the terminal.

Server builds a response payload that includes fields for the original text, alternative text, risk levels, and recommendation messages, serializes this payload into a response format such as JSON, and sends it back to the terminal via an HTTP response.

### Step 18:

Terminal receives the server response and updates the user interface.

Terminal presents the suggested text and recommendations to the user.

Input: The response payload containing alternative character information and control information.

Output: A visual representation of the alternative text and warnings on the terminal screen.

Terminal parses the response, extracts the alternative text and recommendation flags, displays the alternative text in an editable field, shows labels indicating the original and final risk levels, and renders messages such as “Original text has high flaming risk” or “We recommend not posting this content.”

### Step 19:

User reviews the alternative character information and control information.

User decides how to proceed based on the server's suggestions.

Input: The displayed alternative text and recommendation messages.

Output: A user choice to accept, modify, or cancel the post.

User reads the suggested wording, compares it with the original, and may press buttons such as “Use suggested text” or “Cancel,” thereby providing input to the terminal that determines the next action.

### Step 20:

Terminal executes the user's chosen action and, if applicable, transmits the final post.

Terminal either sends a final post or terminates the posting sequence.

Input: The user's selection and the current text in the input field.

Output: A final posting request to the information sharing service or a cancellation.

Terminal, when the user chooses to post, constructs a final post request containing the text in the input field (which may be the alternative character information), sends it to the posting endpoint of the information sharing service, and optionally closes or resets the input screen. When the user cancels, the terminal discards the draft and may clear the text buffer without sending any posting request.

### Application Example 2

Description follows regarding a flow of the specific processing in an Application Example 2. The units of the system described below are implemented by the data processing device 12 and the smart device 14. The data processing device 12 is called a “server” and the smart device 14 is called a “terminal”.

In online information sharing environments such as social networking services and other content platforms, computing systems increasingly mediate how users create and publish text, images, and videos. Conventional server-side moderation and recommendation systems, however, typically suffer from several technical shortcomings. First, many existing systems rely on static rule sets or simple sentiment classifiers that operate on raw text without deep structural or contextual analysis. As a result, the systems often misclassify content, generate unstable risk scores, and produce outputs that are difficult to calibrate or reuse as training data. This leads to high false positives and false negatives, and forces human reviewers or end users to compensate manually, thereby limiting scalability and degrading the overall efficiency of the computing environment.

Second, typical architectures detect potential issues but do not close the loop by technically integrating generation and evaluation. When a conventional system uses a generative model to propose alternative wording, the generation is usually invoked in a one-shot, ad-hoc manner. There is no systematic mechanism on the server to dynamically construct prompt sentences based on structured risk features, to re-evaluate generated alternatives, and to iteratively refine prompts and model behavior. Consequently, the generative model may produce content that remains risky or inconsistent with platform policies, and the server cannot adaptively improve its prompting and classification logic based on real user interactions.

Third, current systems generally treat user emotion as an external or auxiliary factor, rather than as a first-class technical signal integrated into the content analysis pipeline. They often process emotion with separate tools and do not feed emotion features back into the same machine learning models that calculate risk, nor into the prompt construction for the generative model. This fragmented handling of emotion results in weak feedback to the user and prevents the server from optimizing its internal models using explicit user-reaction data, such as whether suggested alternatives were accepted or rejected.

Fourth, many moderation workflows are batch-oriented and do not provide low-latency, incremental analysis of content while the user is composing it. The lack of a real-time assistance mechanism means the server cannot efficiently compute simplified risk indices and candidate risky expressions on intermediate drafts, and the terminal cannot provide timely guidance. This increases server-side processing spikes at the moment of posting and restricts the ability of the overall system to distribute computation more evenly and reduce redundant analysis.

Therefore, there is a need for an improved computer-implemented system and server architecture that: (1) performs structured multi-modal feature extraction and risk scoring; (2) dynamically constructs and refines prompt sentences to cooperatively control a generative AI model; (3) re-evaluates generated alternatives in a closed loop; (4) integrates user emotion estimation and user interaction logs into model parameter updates; and (5) supports real-time, low-latency risk assistance for partially composed content. Such a system would improve the operation of the underlying computing devices by enabling more accurate, adaptive, and efficient risk evaluation and content generation, while reducing manual interventions and computational waste.

The specific processing by the specific processing unit 290 of the data processing device 12 in Application Example 2 is realized by the following means.

The present invention provides a server comprising a processor, a storage unit, and a communication unit, the processor being configured to preprocess electronic text data and visual media data received from user terminals by using natural language processing and image analysis functions to extract structured features; to compute, by a machine learning model using the extracted features and past-case data stored in the storage unit, a flaming risk index and a risk class for the content; to dynamically construct and transmit prompt sentences including original content and risk-reduction conditions to a generative AI model so as to cause the generative AI model to generate alternative electronic text data with reduced flaming risk; to re-evaluate the generated alternative electronic text data using the same analysis and machine learning pipeline and, when a predetermined criterion is not met, to iteratively modify the prompt sentences and repeat generation; to identify a user emotional state from the electronic text data by an emotion estimation model and to generate, via the generative AI model, feedback information including expression-change proposals or posting-suppression proposals based on the emotional state and the flaming risk index; to perform, while the user is composing the electronic text data, a real-time assistance process in which intermediate drafts are sequentially analyzed to compute simplified risk indices and candidate risky expressions; and to record user interaction information indicating acceptance or rejection of suggested alternatives and final posting decisions, and to update parameters of the machine learning model and prompt-construction logic based on the recorded information. This enables the computing system to more accurately and efficiently evaluate and reduce flaming risk through a closed-loop integration of analysis, prompt-driven generative AI, and user feedback, thereby technically improving the operation of the server and associated terminals by reducing misclassification, lowering latency, and adaptively optimizing model behavior over time.

The term “processor” refers to a hardware or virtual information processing element, such as a central processing unit or a processing core in a computing device, that executes instructions to perform logical operations, data processing, and control functions of the system.

The term “storage unit” refers to any non-transitory information storage medium or combination of media, such as a memory device or a database system, that stores data, models, parameters, past case records, prompt sentences, user interaction logs, and program instructions used by the processor.

The term “communication unit” refers to a hardware or software communication interface, such as a network interface or communication controller, that enables the system to send and receive data to and from external devices, including user terminals and external platforms, over a communication network.

The term “user terminal” refers to an electronic client device, such as a portable computing device, a stationary computing device, or a web-enabled device, used by a user to input content, receive feedback, and communicate with the server.

The term “electronic text data” refers to character-based digital information, such as a post, a message, an advertisement, or a comment, represented in a machine-readable text format that can be processed by natural language processing functions.

The term “visual media data” refers to image-based or video-based digital information, such as still images, moving images, or audiovisual data, that can be analyzed by image analysis or video analysis functions.

The term “analysis function” refers to a set of software modules or processing routines that perform computational analysis on input data, including but not limited to natural language processing of electronic text data and image or video analysis of visual media data, in order to generate structured features.

The term “natural language processing function” refers to a computational function that analyzes human language text to perform operations such as tokenization, part-of-speech tagging, syntactic parsing, entity recognition, sentiment analysis, and extraction of linguistic features.

The term “image analysis function” refers to a computational function that analyzes visual media data to perform operations such as object detection, scene recognition, face detection, or category classification, and to extract features representing the content of images or videos.

The term “features” refers to structured data elements derived from analysis of input content, including but not limited to word sequences, syntactic information, emotion indices, object identification information, category identification information, and other numerical or symbolic descriptors used by machine learning models.

The term “emotion index” refers to a numerical or categorical representation of an emotional attribute, such as anger, joy, sadness, or neutrality, associated with electronic text data or user behavior, and computed by an emotion estimation model or sentiment analysis process.

The term “object identification information” refers to data indicating detected objects or entities in visual media data, such as labels or identifiers for persons, items, symbols, or scenes, produced by an image analysis function.

The term “category identification information” refers to data indicating classifications or categories assigned to content, such as content type, sensitivity level, or thematic group, produced by analysis functions for use in risk evaluation.

The term “machine learning model” refers to a computational model that has been trained on example data to perform tasks such as classification, regression, or scoring, and that processes input features to output a flaming risk index or related predictions.

The term “past case data” refers to stored records representing previous content instances, associated analysis results, and labels, including cases of problematic reactions or non-problematic reactions, used as training or reference information for risk evaluation.

The term “flaming risk index” refers to a numerical value or score indicating a likelihood or degree of negative public reaction, backlash, or problematic escalation that may result from publication of content on an information sharing platform.

The term “risk class” refers to a discrete category assigned to content, such as low risk, medium risk, or high risk, determined based on the flaming risk index according to one or more predefined thresholds.

The term “prompt sentence” refers to an instruction text or input text provided to a generative AI model, the instruction text specifying tasks, constraints, or conditions for generation or analysis of content, including risk reduction requirements.

The term “generative AI model” refers to a computational model based on machine learning, such as a language generation model, that generates new text or other content in response to input data, including prompt sentences, and that can also output analysis or explanations when suitably prompted.

The term “alternative electronic text data” refers to revised or newly generated electronic text content, produced by the generative AI model in response to a prompt sentence, that is intended to reduce flaming risk while preserving relevant information or meaning.

The term “predetermined criterion” refers to a condition or set of conditions defined in advance, such as a threshold for the flaming risk index or a quality metric, used to determine whether generated alternative content is acceptable or whether further refinement is required.

The term “warning information” refers to output data in the form of a message or signal that recommends to a user that publication, sharing, or continuation of certain content be suspended, postponed, or reconsidered, based on a classification result or flaming risk index.

The term “user emotional state” refers to an inferred psychological state or affective condition of a user, such as anger, frustration, happiness, or calmness, estimated from electronic text data or other user signals by an emotion estimation model.

The term “emotion estimation model” refers to a computational model that processes input data, such as electronic text data or usage patterns, to estimate a user emotional state and output one or more emotion indices.

The term “feedback information” refers to content presented to the user that includes recommendations, explanations, or proposals for modifying or suppressing a post, the content being generated or assisted by a generative AI model based on an emotional state and a flaming risk index.

The term “expression-change proposal” refers to a suggested modification of wording, tone, or structure of electronic text data intended to reduce flaming risk or emotional intensity while preserving the substantive message.

The term “posting-suppression proposal” refers to a recommendation or instruction suggesting that a user delay, cancel, or substantially alter a potential post in order to reduce flaming risk or avoid negative consequences.

The term “real-time assistance process” refers to a processing mode in which intermediate drafts or partial versions of electronic text data are analyzed with low latency while the user is composing, so that simplified risk indices and candidate risky expressions can be provided back to the user terminal during composition.

The term “candidate risky expressions” refers to words, phrases, or textual segments identified by analysis as being likely to increase flaming risk, and highlighted or outputted to the user for potential modification.

The term “user interaction information” refers to data representing user actions in response to system outputs, including acceptance or rejection of suggested alternative text and decisions to post, postpone, or cancel content, collected for logging and model updating.

The term “prompt-sentence construction process” refers to a sequence of operations executed by the processor to determine the content, structure, and parameters of a prompt sentence for a generative AI model, based on features such as risk indices, emotion indices, and past user interactions.

In one embodiment, a server cooperates with one or more user terminals to implement a content-risk evaluation and rewriting system. The server executes program modules stored in a storage unit by a processor. The server communicates with the user terminals and with an external information sharing platform via a communication unit connected to a communication network.

The server runs on general-purpose computing hardware, such as a rack-mounted server or a virtual machine instance, including at least one central processing unit, a main memory, a non-volatile storage device, and a network interface controller. The server executes an operating system, such as a general-purpose server operating system, and application software including a web framework, a database engine, and analysis libraries. The server stores model parameters and past case data in a database, such as a relational database system. The server stores binary media data in a non-volatile storage device or in an external object storage service.

The terminal is an electronic device such as a smartphone, tablet device, or personal computer. The terminal includes an input device, a display device, a communication module, and a local memory. The terminal runs an application or web client that interacts with the server by sending and receiving messages over a network. The user operates the terminal to input content, confirm warnings, and select alternative text.

The server uses a natural language processing module implemented with libraries such as a syntactic parser and a sentiment analyzer. The server loads a language model that provides tokenization, part-of-speech tagging, dependency parsing, and named-entity recognition. The server uses these functions to convert an input text string into a structured representation including a token array, a dependency tree, a list of named entities, and a set of sentence-level features. The server also applies a sentiment analyzer and an emotion classifier, such as a lexical-based classifier or a neural-network-based classifier, to compute an emotion index vector. The server stores the features and emotion indices in the storage unit as structured records linked to a corresponding post identifier.

The server uses an image analysis module implemented with a computer vision library and, optionally, a cloud-based image recognition service. The server decodes uploaded images and video frames into pixel tensors and applies object detection and classification models, such as convolutional neural networks. The server obtains object identification information and category identification information, such as labels indicating persons, items, symbols, or scenes, and a sensitivity category. The server represents these results as feature vectors, such as one-hot vectors or probability distributions over object classes, and stores them in the storage unit as part of the feature set for the post.

The server constructs a unified feature vector for each post by concatenating or otherwise combining text features, emotion indices, and visual features. For example, the server generates a text embedding for each sentence using a neural encoding model, generates a visual embedding for each image using a convolutional backbone, and concatenates these dense vectors with scalar features such as sentiment polarity, emotion scores, and counts of certain syntactic patterns. The server normalizes these features using stored scaling parameters.

The server uses a machine learning model to compute a flaming risk index from the unified feature vector. In one embodiment, the server uses a feedforward neural network with several fully connected layers and non-linear activation functions. The server stores the trained weights and biases of this network in the storage unit. The server applies the network to the feature vector to produce a scalar output between zero and one representing the flaming risk index. The server then compares the scalar value with fixed or adaptive thresholds to determine a risk class, such as low, medium, or high.

The server trains the machine learning model offline using historical data stored in the storage unit. The server uses a dataset of posts labeled by human reviewers regarding actual or expected reactions. The server divides the dataset into training and validation subsets. The server constructs feature vectors as described above, sets a loss function such as binary cross-entropy or categorical cross-entropy, and updates network parameters by gradient descent with a chosen optimizer. The server may apply regularization techniques and data augmentation, for example by paraphrasing texts or adding noise to embeddings, to improve generalization and robustness. The server stores the trained parameters and may periodically retrain or fine-tune the model using newly collected labeled data.

The server also stores past case data in a structured database that includes, for each case, a feature vector, a label describing the type of incident, and a severity rating. The server uses similarity measures, such as cosine similarity between embeddings, to identify past cases similar to a current post. By combining the output of the neural network with similarity scores to severe past cases, the server can refine the flaming risk index and the associated explanation factors. This combination can be implemented as an additional layer in the network or as a separate scoring function.

The server uses an emotion estimation model to estimate a user emotional state from the input text. The server may use a separate neural network that receives text embeddings and outputs a vector of emotion intensities. The server trains this network with a dataset of texts annotated with emotion labels. The server uses a loss function such as mean squared error or cross-entropy, depending on label type, and updates parameters by gradient descent. The server stores the resulting emotion indices with the post and uses them to adjust later processing.

The server constructs a prompt sentence to be provided to a generative AI model. The server uses a prompt-sentence construction process in which the server selects elements such as: a task description, explicit constraints, the original text, and, in some embodiments, a compact representation of emotion and risk. The server generates a prompt sentence as a natural language string, for example: “Rewrite the following SNS post to reduce flaming risk. Keep the main meaning, remove insults and extreme expressions, and use calm and respectful language. Original post: ‘This product is completely useless and only fools would buy it.’”

The server may add explicit risk labels or emotion descriptions, for example: “The current flaming risk score is high and the user is angry. Rewrite the text to express dissatisfaction in a constructive and non-insulting way.”

For advertisements, the server may construct a prompt sentence such as:
“Rewrite the following advertisement to avoid flaming and negative reactions. Do not attack competitors, and use positive, customer-friendly wording. Original advertisement: ‘Our product is far better than any other brand and only a fool would choose something else.’”

For direct risk analysis, the server may construct a prompt sentence such as:
“Evaluate the flaming risk of the following SNS post and provide a score from 0 to 100 with a brief explanation. Post: ‘This product is totally worthless, and only fools buy it.’”

The server inputs the prompt sentence into a generative AI model via a network connection. The generative AI model is, for example, a transformer-based neural network with an encoder-decoder or decoder-only architecture, pre-trained on large text corpora and then optionally fine-tuned on task-specific examples. The server transmits the prompt sentence as a sequence of tokens and receives a generated output as another sequence of tokens. The server converts the tokens to text and stores the generated text in the storage unit.

The server configures the generative AI model with generation parameters, such as a temperature parameter, a maximum output length, and a penalty for repetition. The server adjusts these parameters depending on the severity of the risk and the type of content. For example, the server may use a lower temperature and shorter maximum length for high-risk posts to obtain conservative, concise rewrites.

The server applies the same analysis pipeline used for original text to the alternative electronic text generated by the generative AI model. The server computes a new flaming risk index and compares it to a predetermined criterion, such as a maximum acceptable value. If the index does not satisfy the criterion, the server modifies the prompt sentence. For example, the server may add an instruction such as “Avoid using any negative adjectives” or “Avoid direct mention of other people or companies” or “Use neutral and factual description only.”

The server then resubmits the modified prompt sentence to the generative AI model. By iterating this cycle, the server enforces a closed-loop control over the generative process, which differs from manual editing or one-shot generation.

The server implements the prompt-sentence construction process as a module that uses rule-based templates and, optionally, learned parameters. The server records the flaming risk index and user interaction outcomes (for example, whether an alternative was accepted) in the storage unit. The server uses these records to update selection probabilities of templates or to adjust weights in a small auxiliary model that chooses constraints for the prompt sentence. In this way, the server gradually learns which instructions in a prompt sentence lead to low-risk outputs that are acceptable to users, thereby improving computational efficiency and quality. The server also generates feedback information that explains to the user why a post is considered risky and how it can be improved. The server may obtain an explanation from the generative AI model by using a prompt sentence such as:
“Analyze the flaming risk of the following post. Output a risk score from 0 to 100 and explain briefly why it might cause backlash. Post: ‘This product is totally worthless, and only fools buy it.’”

The server parses the generated output to extract a numeric score and a textual explanation.

The server stores both in the storage unit and forwards the explanation to the terminal as part of the feedback information. Alternatively, the server may generate the explanation text by an internal rule-based module using the explanation factors stored with the post.

The server implements a real-time assistance function. When the user types text on the terminal, the terminal periodically transmits intermediate drafts to the server. The server uses a reduced set of features and a smaller, specialized model to compute a simplified flaming risk index and identify candidate risky expressions quickly. For example, the server may use only sentiment polarity, presence of certain key words, and simple syntactic patterns. The server returns this simplified index and a list of flagged phrases to the terminal. The terminal highlights the phrases and displays a simple indicator such as “tone is very negative.” This distributed design reduces communication load and computation at the time of final posting because part of the analysis is already performed during composition.

The terminal converts feedback from the server into user interface elements. The terminal displays the original text and the alternative electronic text in separate areas, shows risk scores, and indicates warnings such as “High risk: this post may cause negative reactions.”

The terminal may allow the user to tap a button to replace the original text with the alternative text, or to merge the two. The terminal may also display the explanation text received from the server so that the user understands the specific reasons for the recommendation.

The user operates the terminal to select one of the alternatives or to cancel posting. The terminal sends the decision to the server. The server records the decision, including an indicator of whether the user accepted the alternative electronic text, edited it manually, or rejected it. The server uses these records as training signals to fine-tune the machine learning model and to adjust the prompt-sentence construction process, for example by increasing the preference for templates that historically led to accepted alternatives.

The server thus performs a sequence of technical operations that are not limited to abstract ideas or human mental processes. The server implements specific data structures, such as unified feature vectors combining text embeddings, emotion indices, and visual embeddings.

The server uses concrete neural network architectures, loss functions, and optimization methods to compute flaming risk indices. The server controls a generative AI model by constructing prompt sentences that include structured conditions derived from model outputs and user behavior, and by iteratively refining these prompt sentences based on quantitative evaluation of generated text.

This design yields several technical effects. The server increases accuracy of risk evaluation compared to simple keyword or sentiment rules by using high-dimensional feature vectors and trained neural networks. The server reduces computational waste by reusing intermediate features for both evaluation and generation, and by performing partial analysis in real time during composition. The server improves response time by using a lightweight model for incremental drafts and a more complex model only when necessary. The server improves data management by storing structured logs of prompts, outputs, risk scores, and user interactions, enabling incremental retraining and parameter tuning without manual curation.

Furthermore, the server employs processing sequences and parameter updates that differ from conventional manual moderation or static rule-based systems. The server does not simply automate human editorial judgment; instead, the server introduces a closed-loop control system where the machine learning model, the generative AI model, and the prompt-sentence construction logic mutually constrain and improve each other based on feedback from user actions. This architecture directly improves the operation of the computing system itself by reducing misclassification rates, stabilizing latency, and adapting model behavior without reprogramming core logic.

In another embodiment, the server deploys different versions of the machine learning model and the prompt-sentence templates for different platforms or languages. The server may maintain multiple models in the storage unit and dynamically select one according to metadata provided by the terminal, such as language code or platform type. The server may also support alternative generative AI models, such as encoder-decoder models or domain-specific generators, and route prompt sentences to an appropriate model depending on risk severity or content category.

In another embodiment, the server applies similar processing to audio-only content by first converting audio to text using a speech recognition module and then treating the transcription as electronic text data. The server may also extract acoustic features such as loudness or pitch to estimate user emotion more accurately, and incorporate these features into the unified feature vector.

In another embodiment, the server executes part of the analysis locally on the terminal if the terminal has sufficient processing capability. For example, the terminal may run a small sentiment analyzer or emotion estimator and send only compact indices to the server. This reduces network traffic and offloads some computations from the server, further improving overall efficiency.

Through these embodiments and variations, the server, the terminal, and the user cooperate to implement a technically specific system that integrates structured analysis, machine learning-based risk scoring, prompt-controlled generative AI, emotion estimation, and user-interaction-driven adaptation. This system improves the functioning of the underlying computers by enabling more accurate, efficient, and adaptive control over generation and evaluation of user-generated content, and by reducing latency, resource consumption, and error rates compared to conventional static or manual approaches.

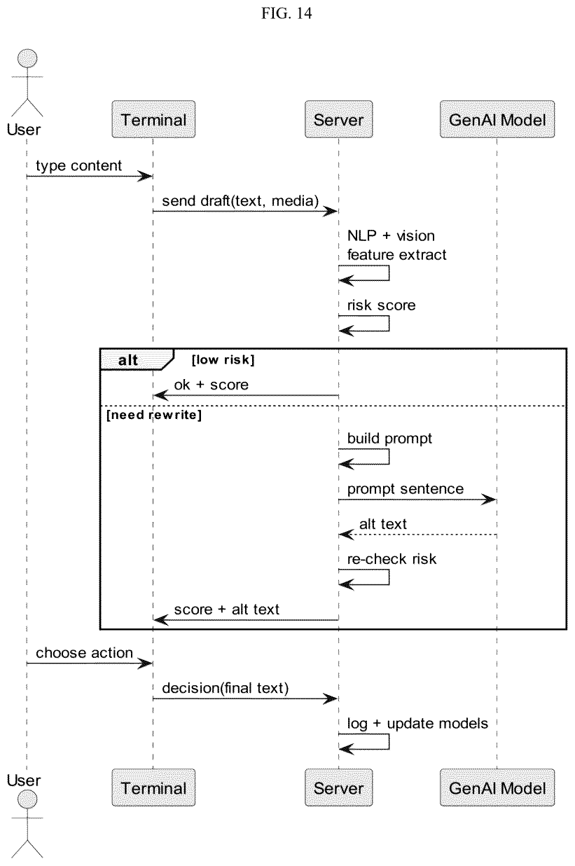

The following describes the processing flow using FIG. 14.

### Step 1:

User inputs draft content on the terminal.

User enters electronic text data, such as a social-media post or an advertisement, into an input field on the terminal and optionally selects visual media data such as images or videos from local storage or a camera.

Input: Raw user text (character string) and selected media files (image/video files).

Output: A local draft object including the text, media file references, and metadata (for example, language, platform type).

Terminal packages the draft object into a request payload and prepares it for transmission by assigning a temporary identifier and attaching user ID and context information.

### Step 2:

Terminal Transmits the Draft Content to the Server.

Terminal opens a network connection via a communication module and sends an HTTP request to the server that includes the electronic text data, the visual media data (or upload URLs), and a flag indicating that risk evaluation and possible rewriting are requested.

Input: Local draft object on the terminal.

Output: Network message containing the draft object delivered to the server's communication unit.

Terminal encodes the text in a predefined character encoding, attaches media binary data or upload tokens, and sets headers indicating content type and size.

### Step 3:

Server receives and validates the draft content.

Server accepts the network message via the communication unit, parses the HTTP headers and body, and extracts the electronic text data, media payloads, and metadata. Server validates that the text length and media size are within allowable limits and that media formats are supported.

Input: Network message from the terminal.

Output: Normalized internal request structure stored in server memory, including validated text, media references, and metadata.

Server writes an initial record into a storage unit with a unique post identifier, the original text, pointers to temporarily stored media, a timestamp, and a processing state flag.

### Step 4:

Server performs natural language preprocessing of the text.

Server applies a natural language processing function to the electronic text data by invoking a tokenizer, a part-of-speech tagger, a dependency parser, and a named-entity recognizer.

Server converts the input string into a token list, a syntactic dependency tree, a list of entity labels, and derived sentence-level attributes.

Input: Original electronic text data associated with the post identifier.

Output: Structured text features including token sequences, part-of-speech tags, dependency relations, entity labels, and basic statistics (such as sentence count and token frequencies). Server stores these features in the storage unit as a feature record linked to the post identifier.

### Step 5:

Server computes sentiment and emotion indices.

Server applies a sentiment analysis module and an emotion estimation model to the structured text features or to the raw text. Server calculates a sentiment polarity score and an emotion vector, for example containing values for anger, joy, sadness, and fear.

Input: Structured text features and/or original text.

Output: Sentiment polarity score and emotion index vector associated with the post identifier.

Server normalizes the scores to a fixed range and writes them to the feature record in the storage unit.

### Step 6:

Server analyzes visual media data.

Server retrieves uploaded image and video files from local storage or an external object storage service using stored file references. Server decodes each medium into pixel data, extracts key frames for videos, and applies an image analysis function including object detection and category classification.

Input: Visual media data linked to the post identifier.

Output: Visual feature vectors containing object identification information, category identification information, and sensitivity indicators for each image or key frame. Server aggregates these visual features, for example by averaging probability distributions or concatenating pooled vectors, and stores the aggregated visual feature set in the feature record.

### Step 7:

Server constructs a unified feature vector for risk evaluation.

Server combines text features, sentiment and emotion indices, and visual feature vectors into a single numerical representation. Server may generate dense embeddings for text and images and concatenate them with scalar indicators such as sentiment scores and counts of specific syntactic patterns.

Input: Text feature record, emotion indices, and visual feature set for the post.

Output: Unified feature vector representing the post content in a fixed-length numerical format.

Server normalizes the unified feature vector using stored scaling parameters and caches it in memory for immediate model input.

### Step 8:

Server calculates a flaming risk index and risk class.

Server inputs the unified feature vector into a machine learning model stored in the storage unit, such as a feedforward neural network with trained weights. Server performs matrix multiplications and non-linear activations to compute a scalar flaming risk index.

Input: Unified feature vector for the post.

Output: Flaming risk index (for example, a real value between 0 and 1) and a corresponding risk class (for example, low, medium, or high) determined by comparison with predefined thresholds.

Server writes the risk index and the risk class into the record associated with the post identifier.

### Step 9:

Server determines whether rewriting or posting control is required.

Server evaluates the flaming risk index and the risk class against system policies and checks whether the user requested rewriting. If the class is medium or high, or if rewriting is explicitly requested, server decides to initiate generation of alternative electronic text data. If the risk is low and rewriting is not required, server prepares a simple feedback message confirming that the content is acceptable.

Input: Flaming risk index, risk class, and user options flags.

Output: Decision flag indicating “rewrite required,” “warning only,” or “safe to post.”

Server logs the decision for future analysis.

### Step 10:

Server constructs a prompt sentence for the generative AI model.

Server generates a prompt sentence by combining a task template with the original electronic text data and conditions inferred from the risk and emotion indices. For example, server builds a string such as:
“Rewrite the following SNS post to reduce flaming risk. Keep the main meaning, remove insults and extreme expressions, and use calm and respectful language. Original post: ‘This product is completely useless and only fools would buy it.’”

Server may insert the emotion state, such as anger, into the prompt to further constrain generation.

Input: Original electronic text data, flaming risk index, risk class, and emotion index vector.

Output: Prompt sentence text to be sent to the generative AI model.

Server stores the prompt sentence in the storage unit as part of a prompt log linked to the post identifier.

### Step 11:

Server invokes the generative AI model to generate alternative text.

Server sends the prompt sentence to a generative AI model via a model interface, specifying generation parameters such as temperature, maximum tokens, and output format. The generative AI model, implemented as a trained neural network, processes the tokenized prompt and outputs a series of tokens representing alternative electronic text data.

Input: Prompt sentence constructed by the server.

Output: Generated alternative electronic text string intended to have reduced flaming risk.

Server decodes the tokens into a text string and temporarily stores the alternative electronic text data in the storage unit.

### Step 12:

Server re-evaluates the generated alternative text.

Server applies the same natural language preprocessing and risk evaluation pipeline used for the original text to the alternative electronic text. Server computes a new unified feature vector and feeds it into the machine learning model to obtain a new flaming risk index and risk class.

Input: Alternative electronic text data generated by the generative AI model.

Output: Recomputed flaming risk index and risk class for the alternative text.

Server compares the new risk index with a predetermined criterion and decides whether the alternative text is acceptable.

### Step 13:

Server iteratively refines the prompt sentence if necessary.

Server modifies the prompt sentence by adding or tightening constraints, for example by adding instructions such as “Avoid any direct personal attacks” or “Use only neutral and factual statements.” If the recomputed flaming risk index does not satisfy the predetermined criterion, server constructs a modified prompt sentence and repeats the generative process.

Input: Recomputed flaming risk index for the alternative text and the previous prompt sentence.

Output: Modified prompt sentence and, after re-invocation of the generative AI model, a new alternative electronic text string.

Server limits the number of iterations according to configuration to maintain acceptable latency.

### Step 14:

Server generates warning and feedback information for the user.

Server determines, based on the risk class and the evaluation of any alternative text, whether to recommend suspension or postponement of visual media publication. Server composes warning information that may state, for example, “High risk: we recommend postponing or canceling the posting of this video.” Server also composes feedback information including explanations of risk factors and, if available, expression-change proposals and posting-suppression proposals derived from the generative AI model output.

Input: Flaming risk indices and risk classes for original and alternative texts, emotion indices, and classification of visual media.

Output: Structured feedback payload including risk scores, warnings, explanations, and alternative text.

Server records the feedback content in the storage unit and passes it to the communication unit for transmission.

### Step 15:

Server sends the feedback and alternative text to the terminal.

Server transmits a response message containing the warning information, the flaming risk index and class, the explanation text, and any acceptable alternative electronic text data to the terminal over the network.

Input: Feedback payload generated by the server.

Output: Network response received by the terminal that includes all feedback elements linked to the post identifier.

Server updates the processing state flag for the post record to indicate that feedback has been issued.

### Step 16:

Terminal displays the risk information and suggestions.

Terminal parses the server response and updates the user interface. Terminal displays the flaming risk index and class, shows warning messages, and presents the alternative electronic text in a separate editable field. Terminal may highlight specific words or phrases in the original text that the server marked as candidate risky expressions.

Input: Feedback response from the server.

Output: Visual presentation of risk indicators, warnings, and alternative text on the terminal display.

Terminal associates interactive controls with each suggestion so that the user can accept, edit, or ignore the alternative electronic text.

### Step 17:

User reviews the feedback and selects an action.

User reads the risk indicators, warning messages, and alternative text as displayed on the terminal. User may choose to adopt the alternative electronic text as-is, modify it further, retain the original text, remove the content entirely, or postpone posting.

Input: Displayed risk information and alternative text.

Output: User decision captured by the terminal as a set of actions (for example, “accept alternative,” “edit manually,” “cancel posting”).

User performs explicit operations such as tapping buttons or editing text fields to express the decision.

### Step 18:

Terminal transmits the user decision to the server.

Terminal encodes the user's action, including whether the alternative text was accepted or rejected and whether posting is confirmed or canceled, into a decision message linked to the post identifier. Terminal sends this message to the server.

Input: User decision and final text version displayed on the terminal.

Output: Decision message delivered to the server, including a copy of the final text to be posted if posting is confirmed.

Terminal may also include timing information or additional metadata about user interaction.

### Step 19:

Server records user interaction information and updates model parameters.

Server parses the decision message, records whether the user accepted or rejected the alternative text and whether the content was ultimately posted. Server writes this user interaction information into the storage unit. Server uses aggregated interaction data in batch or periodic training jobs to update machine learning model parameters and to adjust prompt-sentence construction logic, for example by changing weights or selection rules for templates that historically led to accepted low-risk alternatives.

Input: Decision message from the terminal and existing prompt and risk logs.

Output: Updated training dataset, revised model parameters, and updated prompt construction rules stored in the storage unit.

Server thereby closes the feedback loop, improving future risk evaluation and generation behavior based on past user responses.

### Step 20:

Terminal and server complete posting or cancellation.

If the user confirmed posting, terminal either sends the final text and media directly to an external information sharing platform or instructs the server to relay the content through an application programming interface. If the user canceled posting, terminal may simply close the interface, and server records the cancellation as part of the interaction history.

Input: Final posting decision and final content version.

Output: Successful posting to the external platform, or recorded cancellation in server logs without posting.

Server may, in the case of posting, store the final flaming risk index and content snapshot for monitoring and for future training or auditing.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Moreover, although the processing by the data processing system 10 described above was executed by the specific processing unit 290 of the data processing device 12 or by the control unit 46A of the smart device 14, the processing may be executed by a specific processing unit 290 of the data processing device 12 and a control unit 46A of the smart device 14. Moreover, the specific processing unit 290 of the data processing device 12 acquires and collects information needed for processing from the smart device 14 or from an external device or the like, and the smart device 14 acquires and collects information needed for processing from the data processing device 12 or from an external device or the like.

For example, a collection unit is implemented by the control unit 46A of the smart device 14 and/or by the specific processing unit 290 of the data processing device 12. For example, an acquisition unit acquires number-of-steps data using the camera 42 and/or the communication I/F 44 of the smart device 14, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the output device 40 of the smart device 14 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart device 14.

### Second Exemplary Embodiment

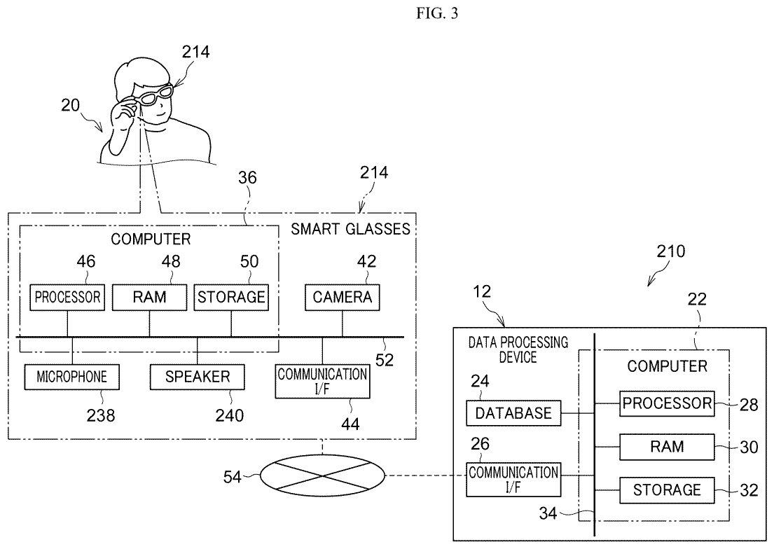

FIG. 3 illustrates an example of a configuration of a data processing system 210 according to a second exemplary embodiment.

As illustrated in FIG. 3, the data processing system 210 includes a data processing device 12 and smart glasses 214. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart glasses 214 include a computer 36, a microphone 238, a speaker 240, a camera 42, and a communication I/F 44. The computer 36 includes a processor 46, RAM 48, and storage 50. The processor 46, the RAM 48, and the storage 50 are connected to a bus 52. The microphone 238, the speaker 240, the camera 42, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

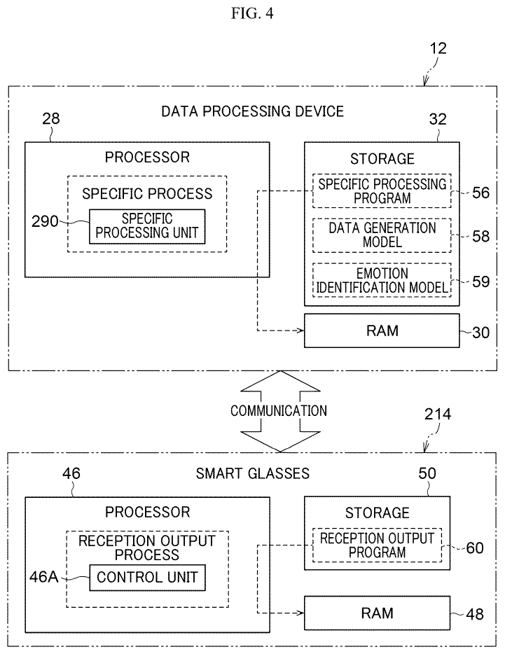

FIG. 4 illustrates an example of relevant functions of the data processing device 12 and the smart glasses 214. As illustrated in FIG. 4, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart glasses 214. A reception and output program 60 is stored in the storage 50. The processor 46 reads the reception and output program 60 from the storage 50 and in the RAM 48 executes the read reception and output program 60. The reception and output processing is implemented by the processor 46 operating as the control unit 46A according to the reception and output program 60 executed in the RAM 48. Note that a configuration may be adopted in which the smart glasses 214 include a data generation model and an emotion identification model similar to the data generation model 58 and the emotion identification model 59, and processing similar to the specific processing unit 290 is performed using these models.

Next, description follows regarding the specific processing by the specific processing unit 290 of the data processing device 12. The units of the system described below are implemented by the data processing device 12 and the smart glasses 214. In the following description the data processing device 12 is called a “server”, and the smart glasses 214 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the smart glasses 214. The control unit 46A in the smart glasses 214 outputs the specific processing result to the speaker 240. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the smart glasses 214, the processing may be executed by a specific processing unit 290 of the data processing device 12 and a control unit 46A of the smart glasses 214. Moreover, the specific processing unit 290 of the data processing device 12 acquires and collects information needed for processing from the smart glasses 214 or from an external device or the like, and the smart glasses 214 acquires and collects information needed for processing from the data processing device 12 or from an external device or the like.

For example, the collection unit is implemented by the control unit 46A of the smart glasses 214 and/or by the specific processing unit 290 of the data processing device 12. For example, an acquisition unit acquires number-of-steps data using the camera 42 and/or the communication I/F 44 of the smart glasses 214, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 of the smart glasses 214 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart glasses 214.

### Third Exemplary Embodiment

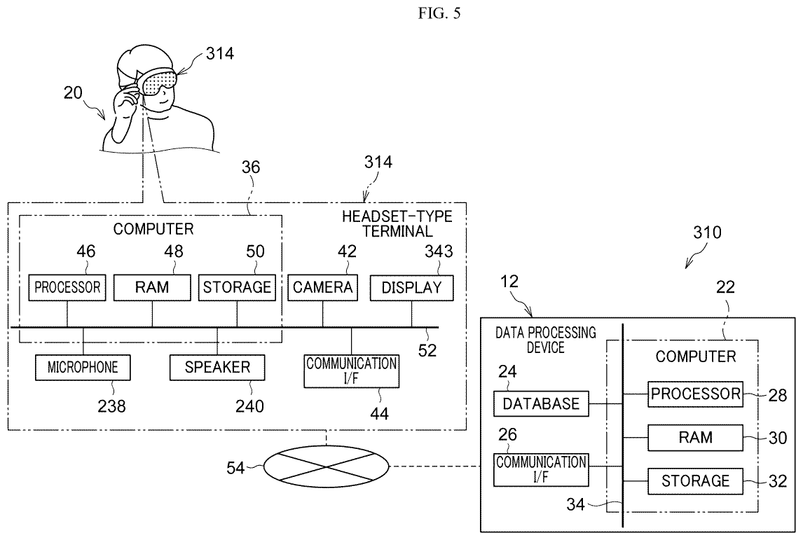

FIG. 5 illustrates an example of a configuration of a data processing system 310 according to a third exemplary embodiment.

As illustrated in FIG. 5, the data processing system 310 includes a data processing device 12 and a headset-type terminal 314. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The headset-type terminal 314 includes a computer 36, a microphone 238, a speaker 240, a camera 42, a communication I/F 44, and a display 343. The computer 36 includes a processor 46, RAM 48, and storage 50. The processor 46, the RAM 48, and the storage 50 are connected to a bus 52. The microphone 238, the speaker 240, the camera 42, the display 343, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

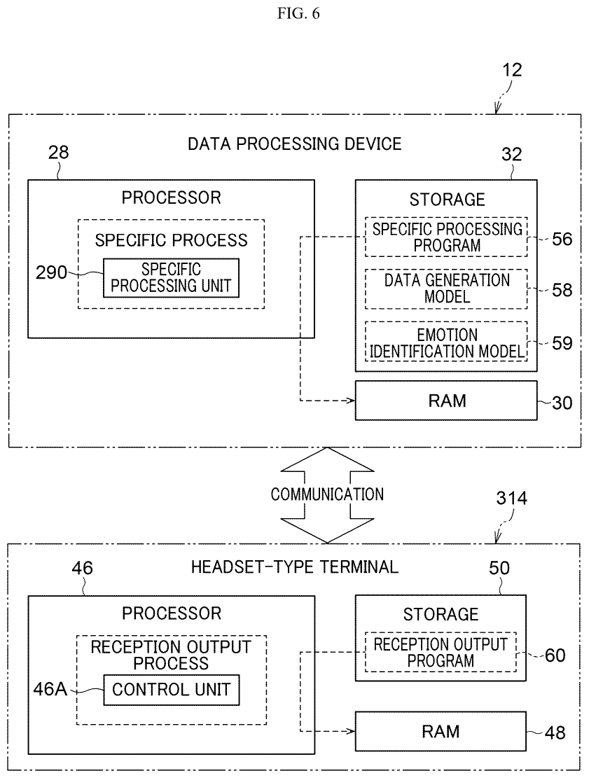

FIG. 6 illustrates an example of relevant functions of the data processing device 12 and the headset-type terminal 314. As illustrated in FIG. 6, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the headset-type terminal 314. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the headset-type terminal 314. In the following description the data processing device 12 is called a “server”, and the headset-type terminal 314 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the headset-type terminal 314. In the headset-type terminal 314, the control unit 46A outputs the result of the specific processing to the speaker 240 and the display 343. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the headset-type terminal 314, the processing may be executed by a specific processing unit 290 of the data processing device 12 and a control unit 46A of the headset-type terminal 314. Moreover, the specific processing unit 290 of the data processing device 12 acquires and collects information needed for processing from the headset-type terminal 314 or from an external device or the like, and the headset-type terminal 314 acquires and collects information needed for processing from the data processing device 12 or from an external device or the like.

For example, the collection unit is implemented by the control unit 46A of the headset-type terminal 314 and/or by the specific processing unit 290 of the data processing device 12. For example, an acquisition unit acquires number-of-steps data using the camera 42 and/or the communication I/F 44 of the headset-type terminal 314, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the display 343 of the headset-type terminal 314 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the headset-type terminal 314.

### Fourth Exemplary Embodiment

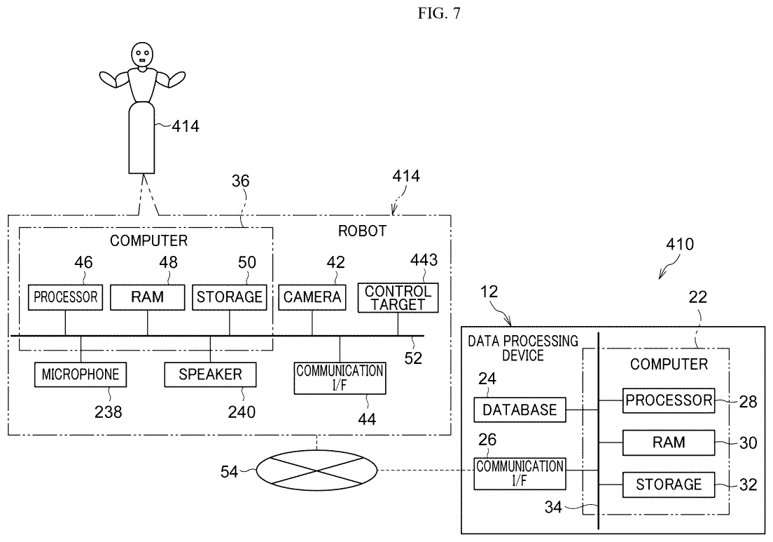

FIG. 7 illustrates an example of a configuration of a data processing system 410 according to a fourth exemplary embodiment

As illustrated in FIG. 7, the data processing system 410 includes a data processing device 12 and a robot 414. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The robot 414 includes a computer 36, a microphone 238, a speaker 240, a camera 42, a communication I/F 44, and a control target 443. The computer 36 includes a processor 46, RAM 48, and storage 50. The processor 46, the RAM 48, and the storage 50 are connected to a bus 52. The microphone 238, the speaker 240, the camera 42, the control target 443, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the robot 414 (for example, with an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

The control target 443 includes a display device, eye LEDs, and motors to drive arms, hands, feet, and the like. The posture and gesture of the robot 414 are controlled by controlling the motors of the arms, hands, feet, and the like. Part of an emotion of the robot 414 can be expressed by controlling these motors. Moreover, a facial expression of the robot 414 can be represented by controlling an illumination state of the eye LEDs of the robot 414.

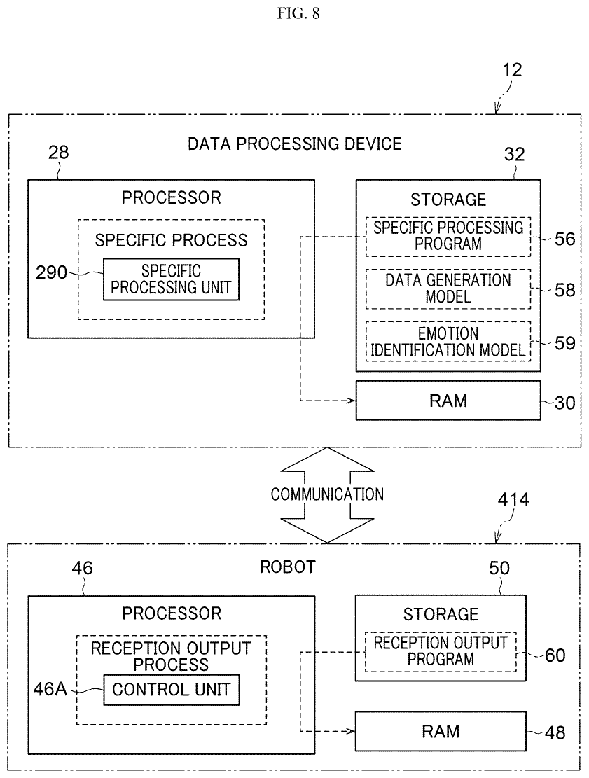

FIG. 8 illustrates an example of relevant functions of the data processing device 12 and the robot 414. As illustrated in FIG. 8, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the robot 414. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the robot 414. In the following description the data processing device 12 is called a “server”, and the robot 414 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the robot 414. In the robot 414, the control unit 46A outputs the result of the specific processing to the speaker 240 and the control target 443. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the robot 414, the processing may be executed by a specific processing unit 290 of the data processing device 12 and a control unit 46A of the robot 414. Moreover, the specific processing unit 290 of the data processing device 12 acquires and collects information needed for processing from the robot 414 or from an external device or the like, and the robot 414 acquires and collects information needed for processing from the data processing device 12 or from an external device or the like.

For example, the collection unit is implemented by the control unit 46A of the robot 414 and/or by the specific processing unit 290 of the data processing device 12. For example, an acquisition unit acquires number-of-steps data using the camera 42 and/or the communication I/F 44 of the robot 414, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the control target 443 of the robot 414 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the robot 414.

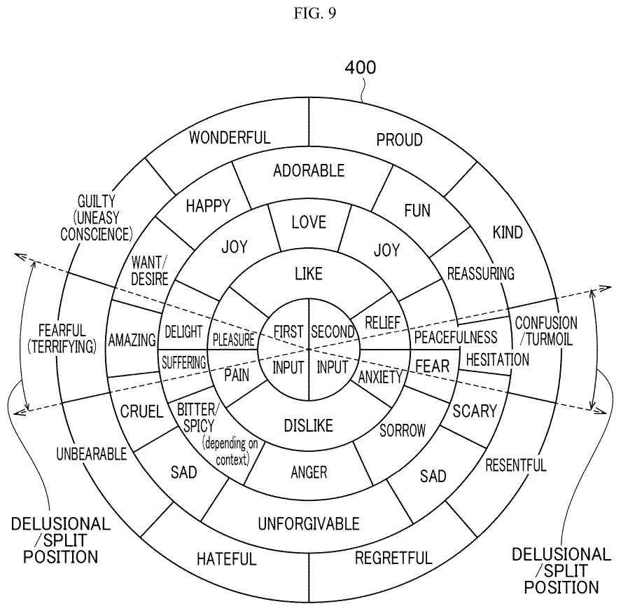

Note that the emotion identification model 59 serves as an emotion engine, and may decide the emotion of a user according to a specific mapping. Specifically, the emotion identification model 59 may decide the emotion of a user according to an emotion map (see FIG. 9) that is a specific mapping. Moreover, the emotion identification model 59 may also decide the emotion of the robot similarly, and the specific processing unit 290 may be configured so as to perform the specific processing using the emotion of the robot.

FIG. 9 is a diagram illustrating an emotion map 400 mapping plural emotions. In the emotion map 400, emotions are arranged in concentric circles that radiate out from the center. Primitive states of emotion are arranged nearer to the center of the concentric circles. Emotions expressing states and actions generated from states of mind are arranged further toward the outside of the concentric circles. Emotions are defined as including both affect and mental states. Emotions generated from reactions occurring in the brain are generally arranged at the left side of the concentric circles. Emotions induced by situational assessment are generally arranged at the right side of the concentric circles. Emotions generated from reactions occurring in the brain that are also emotions induced by situational assessment are generally arranged toward the top and toward the bottom of the concentric circles. Moreover, emotions of “euphoria” are arranged at the upper side of the concentric circles, and emotions of “dysphoria” are arranged at the lower side of the concentric circles. Plural emotions are accordingly mapped in this manner in the emotion map 400 based on a structure giving rise to emotions, and emotions that readily occur at the same time are mapped close to each other.

An example of such emotions is a distribution of emotions in the direction of 3 o'clock on the emotion map 400, generally around a boundary between relief and anxiety. Situational awareness dominates over internal sensations in the right half of the emotion map 400, with an impression of calm.

The inside of the emotion map 400 represents feelings, and the outside of the emotion map 400 represents actions, and so emotions further toward the outside of the emotion map 400 are more visible (are expressed by actions).

Human emotions are based on various balances, such as posture and blood sugar value balances, with a state of dysphoria being exhibited when these balances are far from ideal and a state of euphoria being exhibited when these balances are near to ideal. Even in a robot, a car, a motorbike, or the like, emotions can be thought of as being based on various balances such as orientation and remaining battery balances, with a state called dysphoria being exhibited when these balances are far from ideal and a state called euphoria being exhibited when these balances are near to ideal. An emotion map may, for example, be generated based on the emotion map of Dr. Mitsuyoshi (PhD Dissertation https://ci.nii.ac.jp/naid/500000375379: “Research on the phonetic recognition of feelings and a system for emotional physiological brain signal analysis”, Tokushima University). Emotions belonging to an area called “reaction” where feeling dominates are arranged in the left half of the emotion map. Moreover, emotions belonging to an area called “situation” where situational awareness dominates are arranged in the right half of the emotion map.

There are two types of emotion that facilitate leaning in an emotion map. One is an emotion in the vicinity of the center of negative “penitence” and “reflection” on the situational side. In other words, sometimes a negative “emotion” such as “I don't want to feel this way ever again” and “I don't want to be chided again” is experienced in a robot. Another is a positive emotion in the area of “desire” on the reaction side. In other words, there are times when a positive feeling such as “desire more” and “want to know more” is experienced.

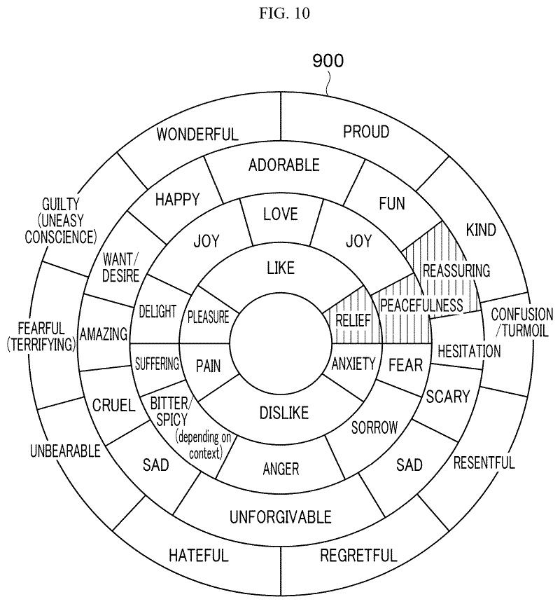

In the emotion identification model 59, user input is input to a pre-trained neural network, and emotion values indicating emotions shown on the emotion map 400 are acquired and the emotions of the user are decided. This neural network is pre-trained based on plural training data sets that each combine a user input with an emotion value indicating an emotion shown on the emotion map 400. The neural network is also trained such that emotions arranged close to each other have values that are close to each other, as in an emotion map 900 illustrated in FIG. 10. In FIG. 10 the plural emotions of “relief”, “peaceful”, and “reassured” are indicated as an example of close emotion values.

Although the system according to the present disclosure has been described mainly as functions of the data processing device 12, the system according to the present disclosure is not limited to being implemented in a server. The system according to the present disclosure may be implemented as a general information processing system. The present disclosure may, for example, be implemented by a software program operating on a personal computer, and may be implemented by an application operating on a smartphone or the like. The method according to the present disclosure may also be supplied to a user in the form of Software as a Service (SaaS).

Although in the exemplary embodiments described above examples are given of embodiments in which the specific processing is performed by a single computer 22, technology disclosed herein is not limited thereto, and distributed processing may be performed for the specific processing, with the specific processing distributed across plural computers including the computer 22. For example, the data generation model 58 may be provided in a device external to the data processing device 12, such that data generation in response to input data is performed in the external device.

Although in the exemplary embodiments described above examples are described of embodiments in which the specific processing program 56 is stored in the storage 32, the technology disclosed herein is not limited thereto. For example, the specific processing program 56 may be stored on a portable, non-transitory, computer readable, storage medium, such as universal serial bus (USB) memory or the like. The specific processing program 56 stored on the non-transitory storage medium is then installed on the computer 22 of the data processing device 12. The processor 28 then executes the specific processing according to the specific processing program 56.

Moreover, the specific processing program 56 may be stored on a storage device, such as a server connected to the data processing device 12 over the network 54, with the specific processing program 56 then being downloaded in response to a request from the data processing device 12 and installed on the computer 22.

Note that there is no need to store the entire specific processing program 56 on the storage device, such as a server connected to the data processing device 12 over the network 54, or to store the entire specific processing program 56 on the storage 32, and part of the specific processing program 56 may be stored thereon.

Hardware resources for executing the specific processing may use various processors as listed below. Examples of processors include, for example, a CPU that is a general-purpose processor that functions as a hardware resource to execute the specific processing by executing software, namely a program. Moreover, the processor may, for example, be a dedicated electronic circuit that is a processor having a circuit configuration custom designed for executing the specific processing, such as a field-programmable gate array (FPGA), a programmable logic device (PLD), or an application specific integrated circuit (ASIC). Memory is inbuilt or connected to each of these processors, and the specific processing is executed by each of these processors using the memory.

The hardware resource that executes the specific processing may be configured from one of these various processors, or may be configured from a combination of two or more processors of the same or different type (for example, a combination of plural FPGAs, or a combination of a CPU and a FPGA). The hardware resource executing the specific processing may be a single processor.

Examples of configurations of a single processor include, firstly, a configuration of a single processor resulting from combining one or more CPU and software, in an embodiment in which this processor functions as the hardware resource for executing the specific processing. Secondly, as typified by a System-on-chip (SOC) or the like, there is also an embodiment that uses a processor realized by a single IC chip to function as an overall system including plural hardware resources for executing the specific processing. Adopting such an approach means that the specific processing is realized using one or more of the various processors described above as hardware resource.

Furthermore, more specifically, an electrical circuit that combines circuit elements such as semiconductor elements or the like may be employed as a hardware structure of these various processors. The specific processing is merely an example thereof. This means that obviously redundant steps may be omitted, new steps may be added, and the processing sequence may be swapped around within a range not departing from the spirit of the present disclosure.

The described content and drawing content illustrated above are a detailed description of parts according to the present disclosure, and are merely examples of the present disclosure. For example, description related to the above configuration, function, operation, and advantageous effects is a description related to examples of the configuration, function, operation, and advantageous effects of parts according to the present disclosure. This means that obviously redundant parts may be eliminated, new elements may be added, and switching around may be performed on the described content and drawing content illustrated above within a range not departing from the spirit of the present disclosure. Moreover, to avoid misunderstanding and to facilitate understanding of parts according to the present disclosure, description related to common knowledge in the art and the like not particularly needing description to enable implementation of the present disclosure is omitted in the described content and drawing content illustrated as described above.

All publications, patent applications and technical standards mentioned in the present specification are incorporated by reference in the present specification to the same extent as if each individual publication, patent application, or technical standard was specifically and individually indicated to be incorporated by reference.

Note that, regarding the above description, the following supplementary notes are further disclosed.

### Example 1

### Supplementary 1

A system comprising a processor,
wherein the processor is configured to
   preprocess character information and video information to be posted to an information sharing service by using information analysis techniques including a natural language processing technique and an image processing technique, and extract feature information from the character information and the video information, and
   generate, on the basis of the extracted feature information, numerical representations that represent the character information and the video information, compare the numerical representations with numerical representations stored in association with past problem cases on the basis of similarity, and calculate a risk index relating to a posting content, and execute a risk determination process that classifies a type of risk and a degree of risk related to the posting content on the basis of the risk index and the extracted feature information, and determine permission of publication or a restriction of a publication range of the posting content according to a result of the risk determination process, and
   when it is determined by the risk determination process that modification of the posting content is recommended, generate a prompt sentence including the posting content, the type of risk, and summary information relating to the past problem cases, input the prompt sentence to a generative artificial intelligence model, and cause the generative artificial intelligence model to generate alternative character information that reduces the risk related to the posting content, and
   notify a terminal device of the alternative character information output from the generative artificial intelligence model and the result of the risk determination process, and update the posting content or manage the posting content as publication-stopped content in response to an adoption input from a user.

### (Supplementary 2)

The system according to Supplementary 1,
wherein the processor is configured to
   convert audio information included in the video information into character information by using a speech recognition technique, and extract additional feature information used for the risk determination process of the posting content by applying the natural language processing technique to the converted character information.

### (Supplementary 3)

The System According to Supplementary 1,
wherein the processor is configured to
   when a similarity between the posting content and the past problem cases in the risk determination process exceeds a predetermined criterion, include, in the prompt sentence used as input to the generative artificial intelligence model, summary information relating to a content classification and an occurrence result of the corresponding problem cases, and
   control a generation policy of the alternative character information.

### Application Example 1

### (Supplementary 1)

A system comprising a processor,
wherein the processor is configured to
   receive, from a terminal device, posting information including textual information and image information as input, and extract semantic feature information and sentiment feature information from the textual information by using a natural language processing algorithm,
   extract image feature information from the image information by using an image recognition algorithm, and generate integrated feature information representing the posting information based on the semantic feature information, the sentiment feature information, and the image feature information,
   compare the integrated feature information with case feature information stored in a flame-incident database in association with historical posting information for which an online backlash has occurred, calculate a similarity between the integrated feature information and the case feature information by using a similarity calculation algorithm, and calculate a flame-risk index and a flame-risk category by using a flame-risk evaluation model based on the similarity and the integrated feature information,
   input, when the flame-risk index or the flame-risk category exceeds a predetermined threshold, instruction information including a prompt sentence to a generative artificial intelligence model, the instruction information being generated based on the posting information and the flame-risk index and being configured to cause the generative artificial intelligence model to generate explanation information describing the flame risk and alternative posting information or alternative expression information that reduces the flame risk, and acquire the explanation information and correction candidate information output from the generative artificial intelligence model,
   generate warning information including at least part of the flame-risk index, the flame-risk category, the explanation information, and the correction candidate information, transmit the warning information to the terminal device, and cause the terminal device to display the warning information so that a user is prompted to select modification of the posting information or cancellation of posting, and
   acquire, from the terminal device, selection operation information indicating the modification or the cancellation performed by the user, and output control information regarding publication or restriction of publication of the posting information in accordance with the selection operation information.

### (Supplementary 2)

The system according to supplementary 1,
wherein the processor is configured to
   execute a learning process for learning or updating the flame-risk evaluation model based on the semantic feature information and the sentiment feature information extracted from the textual information, the image feature information extracted from the image information, and
   the similarity with the flame-incident database.

### (Supplementary 3)

The system according to supplementary 1,
wherein the processor is configured to
   generate, as the prompt sentence to be input to the generative artificial intelligence model, at least one of an explanation request sentence and a correction request sentence including at least one of summary information of the posting information, summary information of content of the image information, the flame-risk category, and information indicating an emotional state of the user, and input at least one of the explanation request sentence and the correction request sentence to the generative artificial intelligence model.

### Example 2

### (Supplementary 1)

A system comprising a processor,
wherein the processor is configured to
   receive character information transmitted to an information sharing service from a terminal device, perform preprocessing on the character information, and store the preprocessed character information as structured data,
   apply a language analysis algorithm to the structured data to calculate emotion information and harmfulness information, extract feature values from the structured data, and generate analysis result data,
   generate a semantic representation of the character information based on the analysis result data, search a stored flaming case database for similar cases by using the semantic representation, calculate a flaming risk index by integrating similarity to the similar cases and the analysis result data, and classify the flaming risk index into a plurality of risk levels,
   when the flaming risk index is determined to be equal to or higher than a predetermined level,
   generate a prompt sentence, based on the character information and a rewriting policy corresponding to the flaming risk index, for input to a generative AI model, and input the prompt sentence to the generative AI model to cause the generative AI model to generate alternative character information for reducing the flaming risk,
   re-evaluate the alternative character information generated by the generative AI model based on the flaming risk index and determine a final flaming risk level for the alternative character information, and
   when the final flaming risk level exceeds a predetermined threshold, generate control information for recommending a temporary stop or cancellation of publication or transmission of a corresponding post to a user, and transmit the alternative character information and the control information to the terminal device for display.

### (Supplementary 2)

The system according to supplementary 1,
wherein the processor is configured to calculate an embedding representation of the character information when generating the semantic representation, and to calculate the flaming risk index based on a similarity between the embedding representation and embedding representations stored in the flaming case database.

### (Supplementary 3)

The system according to supplementary 1,
wherein the processor is configured to select or generate the prompt sentence from a template based on the flaming risk index and the analysis result data, and to embed the character information into the prompt sentence so as to dynamically customize input content to the generative AI model.

### Application Example 2

### (Supplementary 1)

A system comprising a processor, a storage unit accessible by the processor, and a communication unit configured to exchange information with an external information sharing platform,
wherein the processor is configured to
   preprocess electronic text data and visual media data acquired from a user terminal by using an analysis function including a natural language processing function and an image analysis function, and to extract features including word sequences, syntactic information, emotion indices, object identification information, and category identification information,
   calculate a flaming risk index related to the electronic text data and the visual media data by using a machine learning model based on the features and past case data stored in the storage unit, and classify posting information into at least one of a low-risk class, a medium-risk class, and a high-risk class according to the flaming risk index,
   dynamically construct a prompt sentence as an instruction sentence to be input to a generative AI model according to the flaming risk index and a classification result, input the prompt sentence including original electronic text data and flaming-risk-reduction conditions into the generative AI model, and control the generative AI model to generate alternative electronic text data with reduced flaming risk,
   re-evaluate a flaming risk index of the alternative electronic text data by reapplying the analysis function and the machine learning model to the alternative electronic text data, and, when a predetermined criterion is not satisfied, modify conditions of the prompt sentence and repeat a generation process,
   generate warning information recommending suspension or postponement of publication or sharing of the visual media data to a user when the classification result satisfies a predetermined condition, and transmit the warning information to the user terminal, apply an emotion estimation model to the electronic text data to identify an emotional state of the user, and generate, by the generative AI model, feedback information including a proposal for expression change or a proposal for posting suppression for alleviating the emotional state based on the emotional state and the flaming risk index, and generate output data for presenting the feedback information to the user terminal, and
   record operation content of the user regarding acceptance or rejection of the alternative electronic text data and final posting permission or prohibition, the operation content being received from the user terminal, and update parameters of the machine learning model and parameters of a prompt-sentence construction process based on the recorded operation content.

### (Supplementary 2)

The system according to supplementary 1,
wherein the processor is configured to perform a real-time assistance process in which, while the user is inputting the electronic text data, the processor sequentially analyzes intermediate versions of the electronic text data by the analysis function, calculates a simplified flaming risk index and candidate risky expressions, and notifies the user terminal of the simplified flaming risk index and the candidate risky expressions.

### (Supplementary 3)

The system according to supplementary 1,
wherein the processor is configured to generate a prompt sentence requesting, from the generative AI model, a response including both a numerical indicator of flaming risk and a reason explanation for the flaming risk evaluation, extract the numerical indicator and the reason explanation from the response, record the numerical indicator and the reason explanation in the storage unit, and present the reason explanation to the user terminal as explanatory information.

What is claimed is:

1. A system comprising:
circuitry configured to:
receive, via a communication interface coupled to a packet-switched network, character information and video information to be posted to an information sharing service from a terminal device, and preprocess the character information and the video information using information analysis techniques comprising a natural language processing technique and an image processing technique;
extract feature information from the character information and the video information, generate numerical representations based on the extracted feature information, and compare the numerical representations with numerical representations stored in association with past problem cases in a storage device to calculate a risk index;
execute a risk determination process that classifies a risk type and a risk degree of the posting content based on the risk index and the extracted feature information, and determine a permission status or a publication range restriction of the posting content based on the risk determination result;
when the risk determination process recommends modification of the posting content, generate a structured prompt sentence comprising the posting content, the risk index, and candidate risk expressions, supply the prompt sentence to a generative AI model, and obtain modified content from the generative AI model; and
receive user emotion data from the terminal device, apply an emotion recognition model to the user emotion data to generate an emotional state representation, and generate feedback based on the emotional state representation for transmission to the terminal device via the communication interface.

2. The system according to claim 1, wherein the circuitry is configured to apply a natural language processing model comprising tokenization, named entity recognition, and semantic similarity analysis to the character information to extract linguistic feature information, and compare the linguistic feature information with stored past problem case representations to identify candidate risk expressions.

3. The system according to claim 2, wherein the circuitry is configured to generate a prompt sentence requesting from the generative AI model a response comprising a numerical indicator of risk and a reason explanation, extract the numerical indicator and the reason explanation from the response, and transmit the reason explanation to the terminal device as explanatory information.

4. The system according to claim 3, wherein the circuitry is configured to record the numerical indicator, the reason explanation, and the modified content in the storage device, and use the recorded data to update numerical representations associated with past problem cases.

5. The system according to claim 4, wherein the circuitry is configured to apply a similarity scoring model to the modified content to verify that the modified content preserves the original intent while reducing identified risk expressions, and re-prompt the generative AI model when the similarity score falls below a preservation threshold.

6. The system according to claim 1, wherein the circuitry is configured to apply an image processing pipeline comprising object detection, scene classification, and facial recognition to video information received from the terminal device to extract visual feature information, and use the visual feature information in the risk index calculation.

7. The system according to claim 6, wherein the circuitry is configured to apply a privacy detection model to the visual feature information to identify whether the video information contains identifiable personal information, and incorporate a privacy risk indicator in the risk determination process.

8. The system according to claim 1, wherein the circuitry is configured to apply a speech recognition technique to audio content included in the video information to extract transcript text, and incorporate the transcript text as additional character information in the feature extraction and risk index calculation.

9. The system according to claim 8, wherein the circuitry is configured to apply a sentiment analysis model to the transcript text to generate a sentiment score, and combine the sentiment score with the linguistic feature information in the risk index calculation.

10. The system according to claim 1, wherein the circuitry is configured to apply a vector embedding model to the extracted feature information to generate dense numerical representations, and apply a cosine similarity measure to compare the numerical representations with stored past problem case representations.

11. The system according to claim 10, wherein the circuitry is configured to retrieve a predefined number of nearest-neighbor past problem cases based on the cosine similarity measure, and incorporate metadata of the retrieved cases as contextual parameters in the structured prompt sentence.

12. The system according to claim 1, wherein the circuitry is configured to apply a multi-class classification model to the risk index and the extracted feature information to classify the risk type into a plurality of predefined risk categories, and apply risk-category-specific thresholds in the publication range restriction determination.

13. The system according to claim 12, wherein the circuitry is configured to apply different structured prompt sentence templates for each classified risk category, and select the appropriate template for input to the generative AI model based on the classified risk type.

14. The system according to claim 1, wherein the circuitry is configured to apply emotion analysis processing to the character information in the posting content using the natural language processing technique to identify emotional indicators, and incorporate the identified emotional indicators as additional parameters in the risk determination process.

15. The system according to claim 14, wherein the circuitry is configured to adjust the structured prompt sentence based on the emotional indicators to control the generative AI model to generate modified content that addresses the emotional dimension of identified risk expressions.

16. The system according to claim 1, wherein the circuitry is configured to accumulate posting content, risk indices, modification results, and publication permission decisions in the storage device, and apply a model update procedure to the stored data to improve the accuracy of the risk index calculation over time.

17. The system according to claim 16, wherein the circuitry is configured to apply an active learning sampling strategy to select informative accumulated cases for inclusion in a model retraining dataset, and retrain the risk classification model at predetermined update intervals.

18. A system comprising:
circuitry configured to:
receive, via a communication interface coupled to a packet-switched network, character information and video information from a terminal device, apply a natural language processing technique and an image processing technique to extract feature information, and generate numerical representations by applying a vector embedding model to the extracted feature information;
compare the numerical representations with stored past problem case representations using a cosine similarity measure to calculate a risk index, apply a multi-class classification model to classify a risk type and a risk degree, and determine a publication permission status based on the classification result;
generate a structured prompt sentence incorporating the risk index, candidate risk expressions, and contextual metadata from nearest-neighbor past problem cases, supply the prompt sentence to a generative AI model, and obtain modified content with reduced risk expressions;
apply an emotion recognition model to user emotion data received from the terminal device to generate an emotional state representation, and generate emotion-adapted feedback based on the emotional state representation; and
transmit the modified content, the publication permission determination, and the emotion-adapted feedback to the terminal device via the communication interface.

19. The system according to claim 18, wherein the circuitry is configured to accumulate posting content, risk indices, and modification results in the storage device, apply an active learning sampling strategy to select informative cases, and retrain the risk classification model and update stored numerical representations at predetermined update intervals.

20. A method comprising:
receiving, via a communication interface coupled to a packet-switched network, character information and video information to be posted to an information sharing service from a terminal device, and preprocessing the character information and the video information using information analysis techniques comprising a natural language processing technique and an image processing technique;
extracting feature information from the character information and the video information, generating numerical representations based on the extracted feature information, and comparing the numerical representations with numerical representations stored in association with past problem cases in a storage device to calculate a risk index;
executing a risk determination process that classifies a risk type and a risk degree of the posting content based on the risk index and the extracted feature information, and determining a permission status or a publication range restriction of the posting content based on the risk determination result;
when the risk determination process recommends modification of the posting content, generating a structured prompt sentence and supplying the prompt sentence to a generative AI model to obtain modified content; and
receiving user emotion data from the terminal device, applying an emotion recognition model to generate an emotional state representation, and generating feedback based on the emotional state representation for transmission to the terminal device via the communication interface.
